(19) United States
(12) Patent Application Publication
(10) Pub. No.: US 2003/0161629 A1
(43) Pub. Date: Aug. 28, 2003

(54) Linear optical transmission system with failure protection

(76) Inventors: Massimo Frascolla, Novara (IT); Andrea Marchio, Limido Comasco (IT); Via G. Vida, Milano (IT)

Correspondence Address: Finnegan Henderson Farabow, Garrett & Dunner, 1300 I Street NW, Washington, DC, 20005-3315, US

(21) Appl. No.: 10/182,650

(22) PCT Filed: Jan. 30, 2001
(86) PCT No.: PCT/EP01/00978

(30) Foreign Application Priority Data
Jan. 31, 2000 (EP) 00200324.2

(51) Int. Cl. G02F 1/00

(52) U.S. Cl. 398/5; 398/1

(57) ABSTRACT

It is herein described a linear optical transmission system with failure protection wherein the protection is totally accomplished at an optical level, and it operates on the entire system, and not just at a local level. This is accomplished, in a linear system for the transmission of N signals from a first station to a second station, by providing in each station an optical communication path for each signal, and a single shared optical communication path, as well as a communication path for a protocol between the two stations for managing the protection requests arising from optical failure detectors in the optical communication paths and optical switching sections in the two stations for selectively switching the signal propagating along the optical communication path having an optical failure onto the shared communication path. Arrangements of optical switching suitable to the implementation of said system are also described.

The present invention relates to a linear optical transmission system with failure protection.

The expression “linear system” refers to a point-to-point transmission system between two terminal stations with possible interposition of intermediate stations. Thus, in particular, also bus systems are comprised among linear systems. In this description and following claims, the optical transmission in a linear system is defined as linear optical transmission.

A point-to-point transmission system is described, for example, in Govind P. Agrawal, “Fiber-Optic Communication Systems”, second edition, John Wiley & Sons Inc., 1997.

Among the different protection techniques known in the field of telecommunications, reference shall be made hereinafter to 1:N protection. A possible alternative type of protection is the so-called dedicated (1+1 or 1:1) protection, wherein each transmission resource subject to malfunctions or failures is duplicated. Of course, such a protection strategy is very effective, but also very expensive.

In this description and following claims, the expressions “1:N protection” or “shared protection” shall be used as synonyms. The shared protection essentially consists in providing, for N “working” communication paths, an additional path, or “protection path” or “shared path”, which is used in replacement of one of the N “working” paths in case of failure or degradation.

By the term “path” a physical line of transmission/reception and, possibly, processing of optical signals shall be meant. Hereinafter, reference shall be made in particular to WDM (Wavelength Division Multiplexing) transmission systems, wherein optical signals are transmitted on more channels, each of which is associated to a respective transmission wavelength in a preselected spectral band. In this case, each working and protection path is associated to a channel, that is, to a wavelength.

At an electronic level, and particularly for SDH networks (Synchronous Digital Hierarchy), an 1:N protection architecture has been developed (ITU-T (Telecommunication Standardization Sector of the International Telecommunication Union) Recommendation G.841 (October 1998), “Types and characteristics of SDH network protection architectures—Paragraph 7). According to the teachings of this document, failure or malfunction situations are managed through the transmission of information coded via a suitable protocol. Said protocol essentially provides for the use of two Bytes per communication direction for coding the request and the acknowledgement of switching actions from one of the working channels to the protection channel. More in particular, said bytes are sent on the overhead of the signal transmitted on the protection channel. In fact, the Recommendation provides for the bytes to be ignored at the reception even though said bytes are identically transmitted on the working channels.

For further details, reference shall be directly made to the above-mentioned documentation. In particular, the above Recommendation provides for the possibility of using the protection channel, when no protection request is active, for sending extra traffic.

In addition, optical switches shall be widely referred to in this description.

Optical switches are known of the “X” or “2×2” type, wherein there are two inputs, in1 and in2, and two outputs out1 and out2; and optical switches of the “Y” type, usable both as “1×2” switches, that is, with an input in and two outputs out1, out2, and as “2×1” switches, that is, with two inputs in1, in2 and one output out.

X-switches (or 2×2 switches) have a first operating condition (“bar”) wherein the first input in1 is optically connected to the first output out1, and the second input in2 is optically connected to the second output out2; and a second operating condition (“cross”) wherein the first input in1 is optically connected to the second output out2, and the second input in2 is optically connected to the first output out1.

Y-switches of the 1×2 type have a first operating condition wherein the single input in is optically connected to the first output out1, and a second operating condition wherein input in is optically connected to the second output out2.

Y-switches of the 2×1 type have a first operating condition wherein the first input in1 is optically connected to the single output out, and a second operating condition wherein the second input in2 is optically connected to output out.

Moreover, M×1 switches are known, wherein there are M inputs in1, in2, . . . , inM, and one output out, which have M operating conditions wherein a respective input inJ is optically connected to output out; and 1×M switches, wherein there are one input in and M outputs out1, out2, . . . , outM, which have M operating conditions wherein input in is optically connected to a respective output outJ.

From the physical implementation point of view, opto-mechanical switches are known, having semitransparent mirrors tiltable to let the optical beam pass, or to deflect it; MOEMS (Micro Optics Electro-Mechanical Systems) switches, wherein the position of micro-mirrors is controlled by means of silicon or polysilicon transducers; thermo-optical switches, wherein the light is propagated along waveguides made on a substrate of semiconductor material, and is switched from one waveguide to another by varying the refractive index of the waveguides through variations of temperature; magneto-optical switches, wherein a magnetic field induced by Faraday effect allows switching one of the polarizations of the transmitted light; solid-state switches, wherein the refractive index of liquid crystals, when heated through an electric pulse, changes so that one of the polarization modes TE or TM, respectively, passes, and the other one is deviated.

Moreover, digital optical switches (or DOS) are known, comprising a preselected number of input and output waveguides made on a common substrate, for example, a lithium niobate (LiNbO₃) substrate. The number and the arrangement of waveguides can vary according to need. Input and output waveguides are usually connected to optical fibers suitable to convey the transmitted signals, for example single-mode optical fibers. Digital optical switches are described, for example, in W. K. Burns, “Voltage-Length Product for Modal Evolution-Type Digital Switches”, Journal of Lightwave Technology, Vol. 8, No. 6, June 1990.

A commonly used parameter for describing the quality of a switch is the “Extinction Ratio” or E.R. The extinction ratio provides for a measure of the maximum ratio obtainable between the optical powers in two branches of the switch in one of the switching conditions. In the simplest case of an 1×2 switch, wherein the light enters through the input waveguide and exits alternatively through either of the two output waveguides, considering the optical power PL and PH extractable through the two waveguides in each of the two operating conditions described above, the extinction ratio is defined as E.R.=10 log PH/PL (commonly measured in dB). The higher the value of the extinction ratio, the better the behaviour of the switch, since the optical power conveyed into the undesired branch is lower.

Document EP 0 507 379 to Alcatel-Bell describes a protection system for an optical transmitter (or, respectively, receiver) device which accomplishes an 1:N protection wherein, if a transmitter (receiver) undergoes a fault, the transmitter (receiver) is replaced by a spare transmitter (receiver), upon failure detection operations carried out at an electric level, and switching operations carried out both at an electric and at an optical level.

Thus, it can be understood that this document accomplishes a local 1:N protection of the elements of conversion from electric to optical signal (and vice versa, at the reception), but it does not provide for failure management on the optical path between the transmitting site and the receiving site.

The Applicant has noted that the fact of requesting operations at an electric level may not be totally satisfactory in transmission systems, above all in consideration of the continuous increase in the transmission speed.

The technical problem underlying the present invention is to provide, in a linear optical transmission system, an 1:N (or shared) protection totally at an optical level acting on the entire system, and not only at a local level.

Another technical problem underlying the present invention is to provide optical switching arrangements suitable for implementing a system with 1:N protection.

The Applicant has found that the first technical problem is solved, in a linear system for transmitting N signals from a first station to a second station, by providing in each station an optical communication path for each signal, and a single shared optical communication path, as well as a communication path for a protocol between the two stations for managing the protection requests resulting from optical failure detectors in the optical communication paths, and optical switching sections in both stations for selectively switching the signal propagating along the optical communication path having an optical failure onto the shared communication path.

The above-mentioned selective optical communication can be advantageously accomplished by using switching units comprising a set of working switches suitable to maintain the above-mentioned signals on respective optical communication paths in case of absence of failures, and suitable to co-operate with a protection switch for deviating one signal onto the shared communication path in case of failure on the corresponding communication path.

According to need, said working switches can be Y- (1×2 or 2×1) switches or X- (2×2) switches.

The Applicant has found that, by cross-connecting to one another two 1×2 switches and two 2×1 switches and by driving them in an independent way, it is possible to obtain a 2×2 switch that can be effectively used as working switch in the application considered herein. Besides having the advantage of a high extinction ratio, a 2×2 switch of this type can operate in states wherein the signal present at one of its inputs is selectively supplied to one of the two outputs, while the signal present at the other input is blocked. Said situation, for example, is advantageous in an operating condition wherein the 2×2 switch must receive a signal on both its inputs and one of its two outputs must be without signal.

Thus, in a first aspect thereof, the present invention relates to a linear optical transmission system comprising:

a first station for transmitting a preselected number of optical signals;

a second station for receiving said optical signals;

at least one optical communication line between the first and the second station;

both said first station and said second station defining, for each of said optical signals, a respective optical communication working path,

wherein:

at least in said second station, each working path is associated to at least one respective optical failure detector,

both said first station and said second station further define an optical communication protection path,

the system comprises a protocol path for the communication, between the first and the second station, of a protection protocol at least upon the failure detections by said optical failure detectors,

and each of said stations comprises an interposed optical switching section along said working paths for optically switching, in response to the detection of a failure by one of said optical failure detectors, the corresponding optical signal between the corresponding working path and the protection path.

Preferably, each of said stations comprises optical failure detectors at the input of said switching section and/or at the output of said switching section.

Moreover, each of said stations preferably further comprises at least one optical failure detector associated to the protection path and said switching section carries out the switching only in absence of a failure detection by said optical failure detector associated to the protection path.

More in particular, each of said optical failure detectors comprises a photodetector for detecting the optical power.

Preferably, moreover, a group of said optical failure detectors comprises a bit frequency measurement device and/or a bit error rate measurement device.

Typically, each of said stations comprises a wavelength converter section for converting said optical signals of each of said working paths and/or of said protection path from first wavelengths into second wavelengths, or vice versa.

Typically, moreover, said first station comprises a multiplexing section for multiplexing said optical signals of said working paths and/or of said protection path into a multiplexed signal, and said second station comprises a demultiplexing section for demultiplexing said multiplexed signal into said optical signals on said working paths and/or on said protection path.

Advantageously, moreover, in such a system, for bidirectional transmissions, both said first station and said second station further define as many return working paths as said working paths, and a return protection path, wherein each of said return working path is associated to at least one respective return failure detector and said switching sections are further configured so as to further optically switch, in response to the detection of a failure by one of said return failure detectors, the corresponding optical signal between the corresponding return working path and the return protection path.

Preferably, in each of said stations each of said working paths corresponds to a return working path, and said switching sections are further configured so as to optically switch, in response to the detection of a failure on one of the working paths by a corresponding failure detector, the optical signal carried on the corresponding return working path onto the return protection path.

Advantageously, said protocol path comprises said protection path and said return protection path of each of said stations, the signal coding the protection protocol being juxtaposed to the respective optical signal.

Preferably, moreover, each of said stations comprises a processor connected to said optical failure detectors of the respective station for receiving said failure detections, suitable to communicate with the processor of the other station through said protocol path and suitable to control the switching section of the respective station according to said failure detections by said optical failure detectors and to said protection protocol.

More in particular, at least the switching section of said first station is provided with at least one transmitting switching unit having:

associated to each of said working paths, a working input, a working switch and a working output,

associated to said protection path, a protection switch and a protection output,

wherein each of said working switches has a first state in which the respective working input is coupled to the respective working output, and a second state, in response to a failure detection by one of said optical failure detectors associated to the respective working path, wherein the respective working input is coupled to said protection switch, and

wherein said protection switch has as many states as said working paths, in each of which states, in response to the detection of a failure by one of said optical failure detectors, the respective working switch is coupled to said protection output.

In an embodiment, said working switches of said at least one transmitting switching unit are 1×2 switches.

In addition, at least the switching section of said second station is provided with at least one receiving switching unit having:

associated to each of said working paths, a working input, a working switch and a working output,

associated to said protection path, a protection input and a protection switch,

wherein each of said working switches has a first state in which the respective working input is coupled to the respective working output, and a second state, in response to a failure detection by one of said optical failure detectors associated to the respective working path, wherein said protection switch is coupled to the respective working output, and

wherein said protection switch has as many states as said working paths, in each of which states, in response to the detection of a failure by one of said optical failure detectors, said protection input is coupled to the respective working switch.

In an embodiment, said working switches of said at least one receiving switching unit are 2×1 switches.

Alternatively, said working switches of said at least one receiving switching unit are each comprised of a 2×1 switch followed by a beam splitter 50/50.

In another embodiment, said working switches of said at least one transmitting switching unit and/or said working switches of said at least one receiving switching unit are 2×2 switches.

Advantageously, said working 2×2 switches are each comprised of two 1×2 switches and two 2×1 switches, wherein the inputs of the working 2×2 switch correspond to the inputs of the two 1×2 switches, the first outputs of said two 1×2 switches are connected to respective inputs of the first 2×1 switch, the second outputs of 1×2 switches are connected to respective inputs of the second 2×1 switch and the outputs of 2×1 switches correspond to the outputs of said working 2×2 switch.

More advantageously, each of said two 1×2 switches and said two 2×1 switches is provided with a respective driving circuit, said driving circuits driving the respective 1×2 or 2×1 switches in an independent way from one another.

Alternatively, said working 2×2 switches are each comprised of a switch of the 2×1 type connected to a switch of the 1×2 type.

Advantageously, moreover, said 1×2 switches are each comprised of a first, a second and a third 1×2 switch, wherein the input of the first switch serves as input of said 1×2 switch, a first output of the first switch is connected to the input of the second switch, the first output of which serves as first output of said 1×2 switch and the second output of which is without connections, and a second output of the first switch is connected to the input of the third switch, the first output of which is without connections and the second output of which serves as second output of said 1×2 switch.

Similarly, said 2×1 switches are each comprised of a first, a second and a third 2×1 switch, wherein a first input of the first switch serves as first input of said 2×1 switch, the second input of the first switch is without connections, and the output of the first switch is connected to a first input of the third switch, a first input of the second switch serves as second input of said 2×1 switch, the second input of the second switch is without connections and the output of the second switch is connected to a second input of the third switch, the output of the third switch serves as output of said 2×1 switch.

Preferably, said working switches of said at least one transmitting switching unit and/or said working switches of said at least one receiving switching unit are made on a single chip.

Preferably, moreover, said working switches and/or said protection switch of said at least one transmitting switching unit and/or said working switches and/or said protection switch of said at least one receiving switching unit are selected from the group consisting of opto-mechanical switches, MOEMS switches, thermo-optical switches, magneto-optical switches, solid-state switches and digital optical switches.

In a second aspect thereof, the present invention relates to a method for linear optical transmission with failure protection between a first and a second station connected through at least one optical communication line, comprising the steps of:

receiving, in said first station, a preselected number of optical signals through respective input optical connections;

optically conveying said N signals along respective working paths in said first station, along said at least one communication line and along respective working paths in said second station;

said method further comprising the steps of:

carrying out a first check of the conformance with preset requirements of each of said signals along the respective input optical connection;

carrying out a second check of the conformance with preset requirements of each of said signals along the respective working path of said first station and/or along the respective optical working path of said second station;

optically deviating, both in said first station and in said second station, any one of said signals onto a shared protection path, in case said first check on said signal gives a positive result but said second check on said signal gives a negative result.

Advantageously, said method comprises the additional steps, executed should said first check on one of said signals give a negative result, of carrying out a third check on said signal through a respective additional input optical connection and, should said third check give a positive result, receiving said signal through said additional input optical connection.

Preferably, moreover, said method comprises the steps of:

receiving, in said second station, as many additional optical signals as said preselected number;

optically conveying said additional signals along respective additional working paths in said second station, along said at least one communication line and along respective additional working paths in said first station; each of said additional working paths corresponding to one of said working paths;

optically deviating, both in said first station and in said second station, any one of said additional signals on an additional shared protection path, in case for the corresponding signal, said first step of checking gives a positive result, but said second step of checking gives a negative result.

Preferably, each of said first and second checking steps comprises at least one of the following steps:

checking that the optical power is at least equal to a preselected optical power;

checking that the bit frequency is equal to a preselected bit frequency;

checking that the error rate is lower than a preselected error rate.

In a third aspect thereof, the present invention relates to an optical switching device suitable to be used in the above-mentioned transmission system, comprising two 1×2 switches and two 2×1 switches, wherein the inputs of said switching device are the inputs of the two 1×2 switches, the first outputs of said two 1×2 switches are connected to respective inputs of the first 2×1 switch, the second outputs of 1×2 switches are connected to respective inputs of the second 2×1 switch and the outputs of 2×1 switches are the outputs of said switching device, said device comprising, for each of said 1×2 switches and 2×1, a respective driving circuit suitable to drive each of said 1×2 and 2×1 switches independently of the others.

Preferably said 1×2 switches and 2×1 are digital optical switches made on a same semiconductor substrate.

Further features and advantages of the invention will now be described with reference to some embodiments shown in an exemplary and not limitative manner in the attached drawings, wherein:

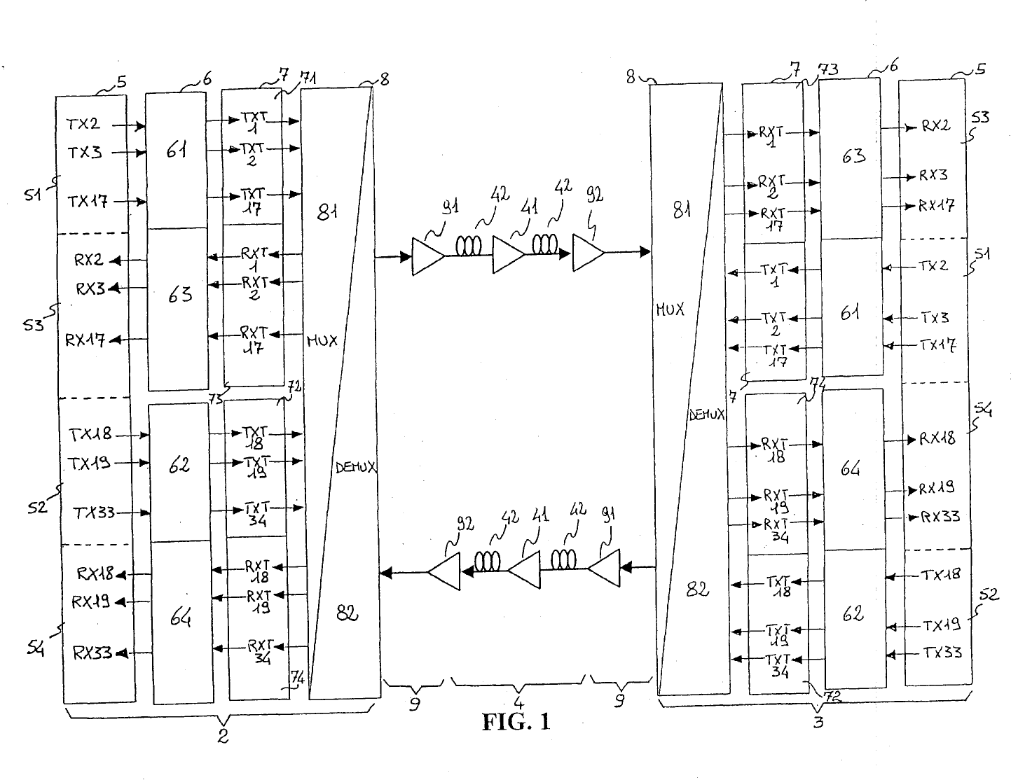

FIG. 1 schematically shows an optical transmission system embodying the present invention;

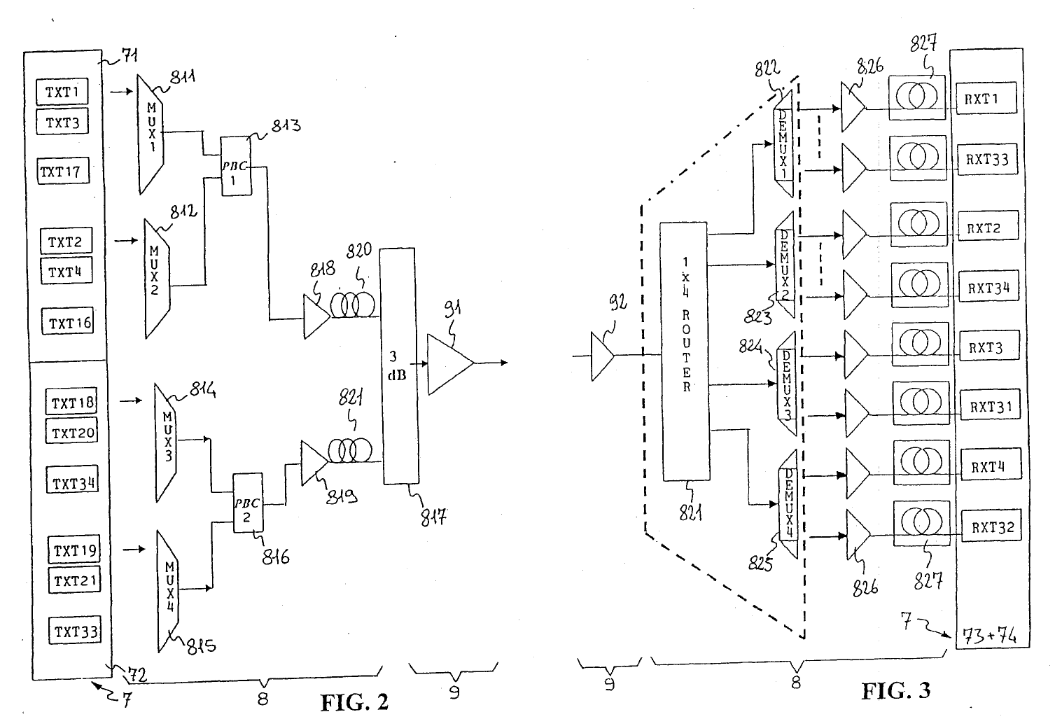

FIG. 2 schematically shows a multiplexing sub-section of the system of FIG. 1;

FIG. 3 schematically shows a demultiplexing sub-section of the system of FIG. 1;

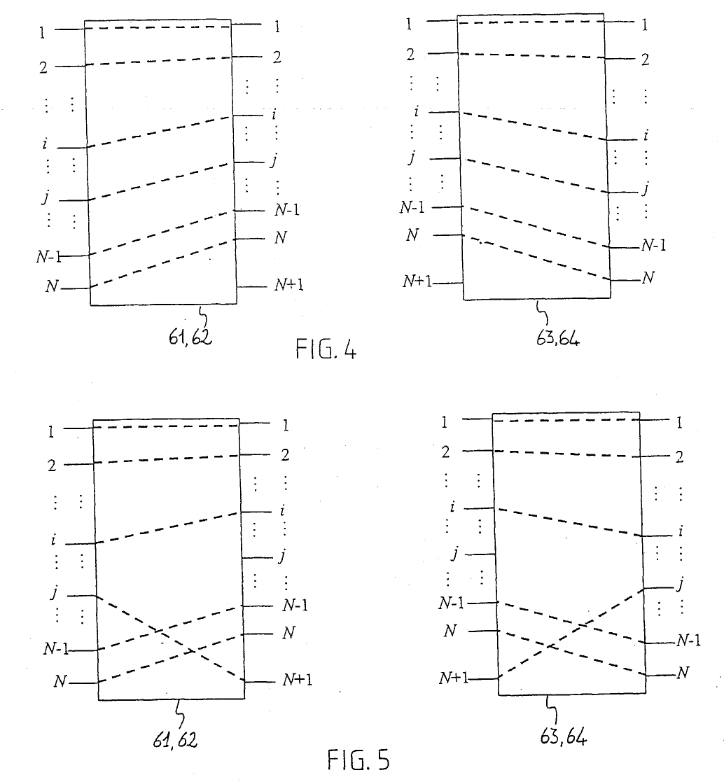

FIGS. 4 to 7 schematically show the functionality of switching units usable in a switching section of the system of FIG. 1;

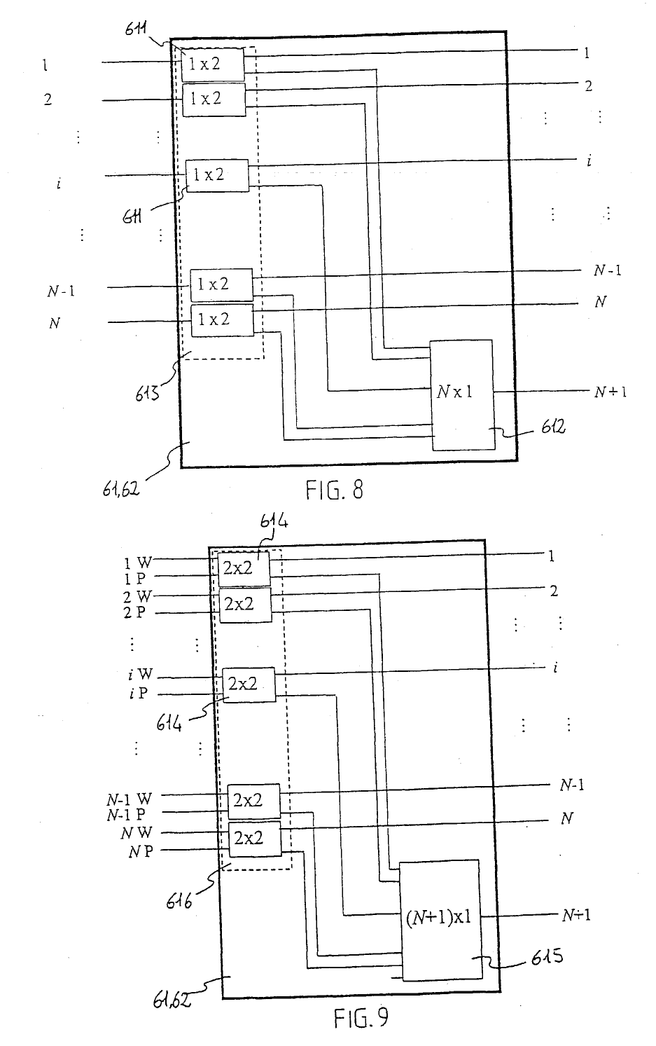

FIGS. 8 to 10 illustrate various architectures of the switching units of FIGS. 4 to 7;

FIGS. 11 to 16 schematically show some optical switches useful in the switching units of FIGS. 4 to 7; and

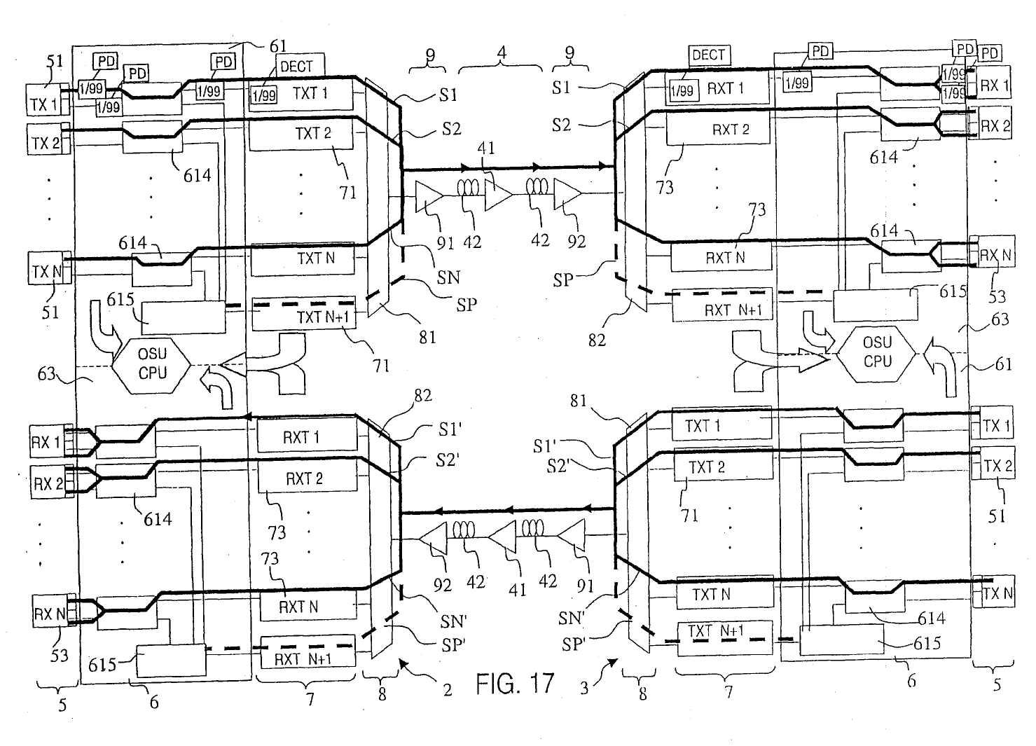

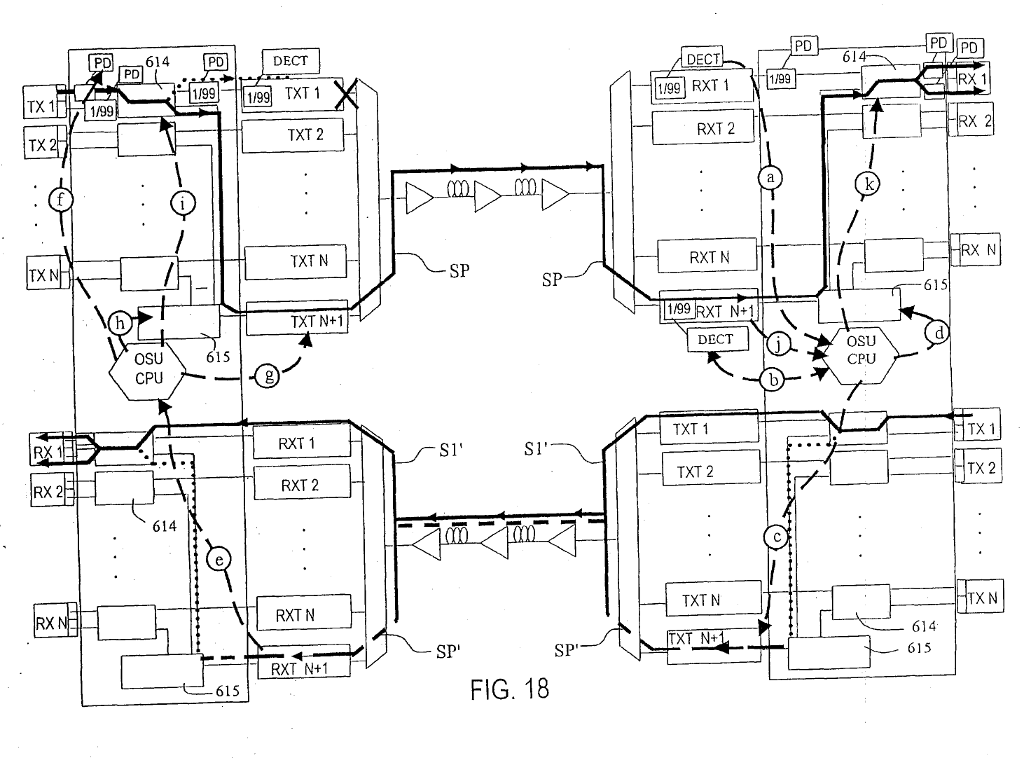

FIGS. 17 and 18 schematically illustrate the operation of the system according to the present invention.

As applicative example of a failure-protected optical transmission system according to the present invention, FIG. 1 shows a system 1 suitable for long-distance bidirectional transmissions (for example, transoceanic communications). System 1 is a WDM (Wavelength Division Multiplexing) system suitable for a wavelength multiplexing transmission of a preselected number of channels at different wavelengths. Each channel is suitable to transmit a respective optical signal wherein the information is modulated at 10 Gbit/s, but of course, the system can operate also at different modulation speeds, for example 40 Gbit/s. The channels are preferably spaced from one another by 50 GHz.

System 1 is protected against failures according to a protection technique of the 1:N type, described in detail hereafter. In the specific case, the system transmits 32 signals on 34 channels, 32 of which are working channels and 2 are protection channels. Preferably, as it shall be described in detail hereafter, channels 1 and 34 are reserved to protection, while channels 2-33 are normally used for transmitting the client's traffic signals. Thus, in this description and following claims, said particular numeration shall be used. In other words, N=16 has been chosen, that is to say, there is one protection channel for each group of 16 working channels.

The spectral distribution of the 32 working channels, for example, can be as follows: 8 channels between about 1529 and 1535 nm; 24 channels between about 1542 and 1560 nm.

System 1 comprises a first and a second station 2, 3, for transmitting and receiving signals, and an optical-fiber communication line 4, which connects stations 2 and 3.

Each station 2, 3 comprises, in succession:

an optical signal input/output section, which typically is a transmitting/receiving section 5,

a switching section 6 (OSS, Optical Switching Section),

a wavelength converter section 7 (WCS),

a multiplexing/demultiplexing section (MUX/DEMUX) 8, and

an amplification section 9.

The transmitting/receiving section 5 comprises a plurality of optical transmitters TXn and a plurality of optical receivers RXn. Transmitters TXn and receivers RXn are defined by a standard optical line terminating equipment (OLTE) of the type suitable for operating with communication protocols of the known type, such as SONET/SDH, ATM and IP. In particular, each transmitter TXn comprises a laser source suitable to emit, at a respective wavelength, an optical signal carrying coded information, and each receiver RXn comprises a photodetector suitable to receive an optical signal carrying coded information. In the specific case, they are the client's traffic signals, at wavelengths λ′₂-λ′₃₃ that have to be transmitted between stations 2 and 3. Wavelengths λ′₂-λ′₃₃ can indifferently be equal to one another, or different.

More in detail, the transmitting/receiving section 5 comprises a first 51 and a second 52 group of transmitters TX2-TX17, TX18-TX33, each comprising sixteen transmitters suitable to transmit on the channels identified by corresponding numbers, and a first 53 and a second 54 group of receivers RX2-RX17, RX18-RX33, each comprising sixteen receivers suitable to receive on the channels identified by corresponding numbers.

More in particular, transmitters TXn (and receivers RXn) can be single-head or double-head, that is, they can have a single optical output (a single optical input) or two optical outputs (two optical inputs) on which the same signal is supplied alternatively or simultaneously. When the SONET/SDH protocol with an electric level dedicated protection of the 1+1 type is used, whereby the client's traffic signals are present on both heads (one of which is “working”, W, while the other is of “protection”, P), transmitters TXn are of the double-head type. Analogously, double-head receivers RXn must preferably receive the client signal on both heads W and P so as to prevent interworking problems with the shared protection provided for according to the present invention.

The switching section 6, which shall be better described hereafter, comprises a first 61 and a second 62 transmitting switching unit, and a first 63 and a second 64 receiving switching unit, wherein the first transmitting switching unit 61 and the first receiving switching unit 63 are preferably made on the same circuit board, as are the second switching units, respectively the transmitting 62 and the receiving 64 units. Preferably, moreover, the switching units 61, 63 and 62, 64 made on the same circuit board, share control elements such as a central processing unit (CPU) to supervise the switching operations, as it shall be described more in detail in the following description and in particular with reference to FIG. 18.

Without entering into the details of the internal structure at this point, each transmitting switching unit 61, 62, is provided with 16 working inputs (N in the general case), that is, coupled to transmitters TX2-TX17, TX18-TX33, for receiving the 16 traffic signals coming therefrom. Moreover, each transmitting switching unit 61, 62 is provided with 17 outputs (N+1 in the general case), respectively 16 (N) working outputs, each associated to a respective input, and one protection output. Actually, in the case of double-head transmitters TXn, each working input of the transmitting switching unit 61, 62 is double; thus, reference shall be made to head W and head P of each input. The traffic signals present at the respective inputs are usually supplied to the working outputs, while no signal is usually supplied to the protection output. In case of a protection request upon a failure detection (as described hereafter) on channel j, the transmitting switching unit 61, 62 couples (as described hereafter) the input j concerned to the protection output, while it does not supply any effective signal to output j.

In a specular manner, each receiving switching unit 63, 64, is provided with 17 inputs (N+1 in the general case), respectively 16 (N) working inputs, and one protection input. Moreover, each receiving switching unit 63, 64 is provided with 16 working outputs, each associated to a respective input, coupled to receivers RX2-RX17, RX18-RX33, for transmitting the 16 traffic signals coming from the communication line 4. Actually, in the case of double-head receivers RXn, each working output of the receiving switching unit 63, 64 is double; thus, reference shall be made to head W and head P of each output. Usually, no effective signal is supplied to the protection input, and the 16 working inputs are coupled to the respective outputs. In the protection state subsequent to a failure on channel j, the receiving switching unit 63, 64 couples the protection input to the working output j, while the working input j remains without connections.

The wavelength converter section 7 comprises a first plurality of signal transponders TXTn operating at the transmission (also referred to as WCM, Wavelength Conversion Module), or shortly, “transmitting transponders”, and a second plurality of signal transponders RXTn operating at the reception, hereafter referred to as “receiving transponders”. In the particular case, there are a first 71 and a second 72 group of transmitting transponders TXT1-TXT17, TXT18-TXT34, and a first 73 and a second 74 group of receiving transponders RXT1-RXT17, RXT18-RXT34, each comprised of 17 (N+1) signal transponders. In each group, a transponder is associated to a respective protection channel. In the particular case, the protection channels are referred to with numeral 1 and numeral 34, so that the working transmitting transponders TXT2-TXT17 are associated to the protection transmitting transponder TXT1; the working transmitting transponders TXT18-TXT33 are associated to the protection transmitting transponder TXT34; the working receiving transponders RXT2-RXT17 are associated to the protection receiving transponder RXT1; and finally, the working receiving transponders RXT18-RXT33 are associated to the protection receiving transponder RXT34.

From the preceding description it is clear that 16 (N) transponders, coupled to the active outputs of the transmitting switching units 61, 62, shall be in use at the same time in each group of transmitting transponders 71, 72; and 16 (N) transponders, coupled to the active inputs of the receiving switching units 63, 64, shall be in use at the same time in each group of receiving transponders 73, 74.

In fact, each transmitting transponder TXTn is suitable to receive an optical signal from a transmitter TXn (through the switching section 6) and to convert the wavelength λ′₂-λ′₃₃ of said signal into a wavelength λ₁-λ₃₄ suitable for the transmission along the communication line 4. For this purpose, each transmitting transponder TXTn comprises a photodetector (not shown), preferably a photodiode, for receiving the optical signal generated by a corresponding transmitter TXn and converting it into a corresponding electrical signal, and an optical source (not shown), preferably a laser, for generating an optical beam the amplitude of which is modulated through the electrical signal. Said modulation can be carried out directly, by directly driving the optical source with the electrical signal, or externally to the optical source, using a modulator (not shown), for example of the Mach-Zehnder type, suitable to receive the optical beam and to emit it again after having modulated its amplitude using the electrical signal. Transmitting transponders TXTn are preferably suitable to operate on the optical signals independently of the particular format with which the data is coded into the signals themselves. Moreover, the signals exiting from the transmitting transponders TXTn are preferably linearly polarised and they are such that odd channels (1, 3, . . . ) have a polarization orthogonal to that of even channels (2, 4, . . . ). This is advantageous to the purposes of the communication along line 4, because, after multiplexing in the multiplexing/demultiplexing section 8, as it shall be described hereafter, adjacent channels have orthogonal polarizations, so that interference phenomena between adjacent channels are reduced.

Each receiving transponder RXTn is suitable to receive an optical signal from the communication line 4, through the multiplexing/demultiplexing section 8, and to convert the wavelength λ₁-λ₃₄ of said signal into a wavelength λ′₂-λ′₃₃ suitable for the reception by a corresponding receiver RXn (through the switching section 6). For this purpose, each receiving transponder RXTn comprises a photodetector (not shown), preferably a photodiode, for receiving the optical signal coming from the communication line 4, and converting it into a corresponding electrical signal, and an optical source (not shown), preferably a laser, for generating an optical beam the amplitude of which is modulated through the electrical signal. Said modulation can be carried out directly, by directly driving the optical source with the electrical signal, or externally to the optical source, using a modulator (not shown), for example of the Mach-Zehnder type, suitable to receive the optical beam and to emit it again after having modulated its amplitude using the electrical signal. Receiving transponders RXTn are preferably suitable to operate on the optical signals independently of the particular format with which the data is coded into the signals themselves.

Besides varying the wavelength of the signals, transponders TXTn and RXTn are suitable to process the same signals, in particular by adding to, or dropping from, respectively, the signal frames, a sequence of bits (channel overhead) coding useful information for managing the transmission system 1 and the protection protocol. This information is not part of the client's useful information (payload), and it is an overhead added to the signal.

The multiplexing/demultiplexing section 8 comprises a multiplexing subsection 81 used at the transmission, and a demultiplexing subsection 82 used at the reception.

In the multiplexing subsection 81, illustrated in FIG. 2, for the first group of channels 1-17 emitted by the transmitting transponders TXT1-TXT17 71, there are preferably a first and a second multiplexer MUX1 811, MUX2 812; the first multiplexer MUX1 811 is provided with nine inputs and one output, and it is suitable to receive odd channels (1, 3, . . . , 17) from the corresponding transmitting transponders (TXT1, TXT3, . . . , TXT17), among which there are eight working channels and a protection channel; the second multiplexer MUX2 812 is provided with eight inputs and one output, and it is suitable to receive even channels (2, 4, . . . , 16) from the corresponding transmitting transponders (TXT2, TXT4, . . . , TXT16). Said multiplexers are of the polarization-maintaining type, and they can be filtering multiplexers or standard passive multiplexers (PM); for example, the multiplexers can comprise AWGs (Array Waveguide Gratings), fiber gratings or interference filters. A first polarization beam combiner PBC1 813 of the known type is provided with two inputs connected, through polarization-maintaining fibers (PMF) at the outputs of multiplexers MUX1 and MUX2 for receiving odd channels and even channels of the first group of channels 1-17 and combining them together into a single output. Thus, as said before, adjacent channels in output from the PBC1 have orthogonal polarizations. In this way, interference phenomena between adjacent channels are reduced.

As an alternative to multiplexers MUX1 811 and MUX2 812, and to the PBC1 813, there can be a single multiplexer MUX1′ (for example an AWG) (not shown), with 17 inputs and one output, suitable to directly multiplex the 17 channels received.

Similarly, for the second group of channels 18-34 emitted by the transmitting transponders TXT18-TXT34 72, there are a third and a fourth multiplexer MUX3 814, MUX4 815; the third multiplexer MUX3 814 is provided with nine inputs and one output, and it is suitable to receive even channels (18, 20, . . . , 34) from the corresponding transmitting transponders (TXT18, TXT20, . . . , TXT34), among which there are eight working channels and a protection channel; the fourth multiplexer MUX4 815 is provided with eight inputs and one output, and it is suitable to receive odd channels (19, 21, . . . , 33) from the corresponding transmitting transponders (TXT19, TXT21, . . . , TXT33). Said multiplexers can be equal to multiplexers MUX1 811, MUX2 812. A second polarization beam combiner PBC2 816 is provided with two inputs connected, through polarization-maintaining fibers (PMF), to the outputs of multiplexers MUX3 814 and MUX4 815 for receiving odd channels and even channels of the second group of channels 18-34 and combining them together into a single output. Also in this case, adjacent channels in output from the PBC2 have orthogonal polarizations for reducing interference phenomena between adjacent channels.

Also in this case, as an alternative to multiplexers MUX3 814 and MUX4 815, and to the PBC2 816, there can be a single multiplexer MUX2′ (for example an AWG) (not shown), with 17 inputs and one output, suitable to directly multiplex the 17 channels received.

Finally, a 3-dB coupler (that is, 50%) 817, for example of the fused-fiber type, is provided with two inputs connected to the outputs of the PBC1 813 and of the PBC2 816, or at the outputs of the 17-channel multiplexers MUX1′ and MUX2′, for receiving the two groups of channels and coupling them on a single output.

In case, for the purpose of carrying out a pre-compensation of the chromatic dispersion of the signals to be transmitted, a pre-compensation pre-amplifier (PTPA) 818, 819, and a pre-compensation fiber 820, 821, can be provided between the output of the PBC1 813 or, respectively, of the multiplexer MUX1′, and the 3-dB coupler 817, as well as between the output of the PBC2 814 or, respectively, of the multiplexer MUX2′, and the 3-dB coupler 817. The amplification provided by amplifiers 826 allows to compensate for the power loss in fibers 827. The pre-compensation fibers 820, 821 can be, for example, standard fibers for positive compensation or DISCO fibers for negative compensation. Alternatively, the pre-compensation can be carried out with a chirped grating.

In a preferred embodiment of the demultiplexing subsection 82, illustrated in FIG. 3, an 1×4 router 821 of the known type, provided with one input and four outputs, is suitable to receive the 34 channels λ1-λ34 from the communication line 4, through the amplification section 9, and to split them, preferably in a cyclic sequence, on the four outputs, that is to say, by providing channels 1, 5, 9, . . . , 29, 33 on the first output; channels 2, 6, 10, . . . , 30, 34 on the second output; channels 3, 7, 11, . . . , 31 on the third output; and channels 4, 8, 12, . . . , 32 on the fourth output. In this way, in the preferred case wherein channels 1-34 are spaced from one another by 50 GHz, the separation of the channels on each output of router 821 is equal to 200 GHz, and thus it is suitable for the demultiplexing capacity of demultiplexers DEMUX described hereafter.

Router 821, for example, can comprise for this purpose a circulator with one input and four outputs, and a plurality of interference filters associated to each output so as to allow the passage only of the channels associated to said output. The four outputs are connected to as many demultiplexers DEMUX1, DEMUX2, DEMUX3, DEMUX4 822-825 (of the known type). Demultiplexers DEMUX1 822 and DEMUX2 823 have one input and nine outputs (as they also manage a protection channel each), while demultiplexers DEMUX3 824 and DEMUX4 825 have one input and eight outputs. Demultiplexers 822-825 split the respective groups of channels into the single channels, and they supply the single channels to respective amplifiers 826. Then, each channel passes through a respective dispersion-compensating fiber 827, as the fibers 820, 821, to reach a respective receiving transponder RXTn 73, 74, in the wavelength converter section 7 described above. The amplification provided by amplifiers 826 allows compensating the power loss into fibers 827.

Of course, there are other possible arrangements not shown, for example an 1×2 router and two demultiplexers 17-to-1, with a double demultiplexing capacity with respect to those described above.

Turning again to FIG. 1, the amplification section 9 comprises, in an essentially known way, at the transmission a transmitter power amplifier (TPA) 91 for amplifying the 34 channels transmitted and supplying them, amplified, to the communication line 4, and it comprises, at the reception, a pre-amplifier 92 (PRE-L) for receiving the 34 channels from the communication line 4 and amplifying them at a level of power suitable for the reception.

Finally, the communication line 4 comprises; for each direction of transmission, a plurality of optical power amplifiers 41 (only one of them is shown in FIG. 1), each arranged between two consecutive spans 42 of optical fiber (of the known type, and with a length of, for example, a hundred kilometres each) and suitable to provide the signals with the optical power precedingly lost. The amplification sections and the communication line can substantially be as described in the international patent application PCT/EP98/03967 filed on Jun. 29, 1998 by the same Applicant.

With reference again to the commutation section 6, FIGS. 4 to 7 schematically show, in the general case of an 1:N protection, the above-mentioned functionality of the switching units 61-64.

When the input/output sections are single-head transmitting/receiving sections 5, the transmitting switching units 61, 62 have topology N×(N+1) (in the particular case, 16×17), and the receiving switching units 63, 64 have topology (N+1)×N (in the particular case, 17×16). FIG. 4 illustrates the working state: in the transmitting unit 61, 62, each input i is connected to the corresponding output i, while there is no effective signal at output N+1; in the receiving unit 63, 64, each input i is connected to the corresponding output i, while there is no effective signal at input N+1, and this is connected to no output. FIG. 5 illustrates the protection state of channel j: in the transmitting unit 61, 62, each input i is connected to the corresponding output i, with the exception of input j, which is connected to output N+1, while there is no effective signal at output j; in the receiving unit 63, 64, each input i is connected to the corresponding output i, with the exception of input j, which is connected to no output, while input N+1 is connected to output j.

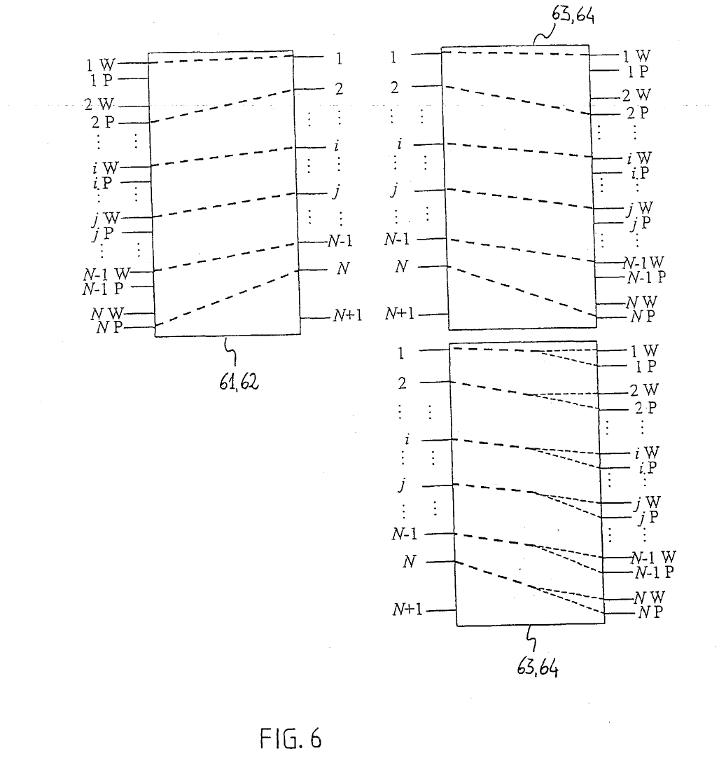

When the input/output sections are double-head transmitting/receiving sections 5, the transmitting switching units 61, 62 have topology (2N)×(N+1) (in the particular case, 32×17), and the receiving switching units 63, 64 have topology (N+1)×(2N) (in the particular case, 17×32). FIG. 6 illustrates the working state: in the transmitting unit 61, 62, one head (working head W or protection head P, carrying the effective signal of the respective transmitter TXn of the transmitting/receiving section 5) of each input i is connected to the corresponding output i, while there is no effective signal at output N+1; in the receiving unit 63, 64, each input i is connected to the corresponding output i, while there is no effective signal at input N+1, and this is connected to no output. According to the strategy used, the signal can be sent to a single head (working W or protection P) of each output i, as exemplified in the top diagram, or to both heads W and P, as exemplified in the bottom diagram. Finally, it must be noted that the head used at the transmission, W or P, can be different from that used at the reception for the same channel.

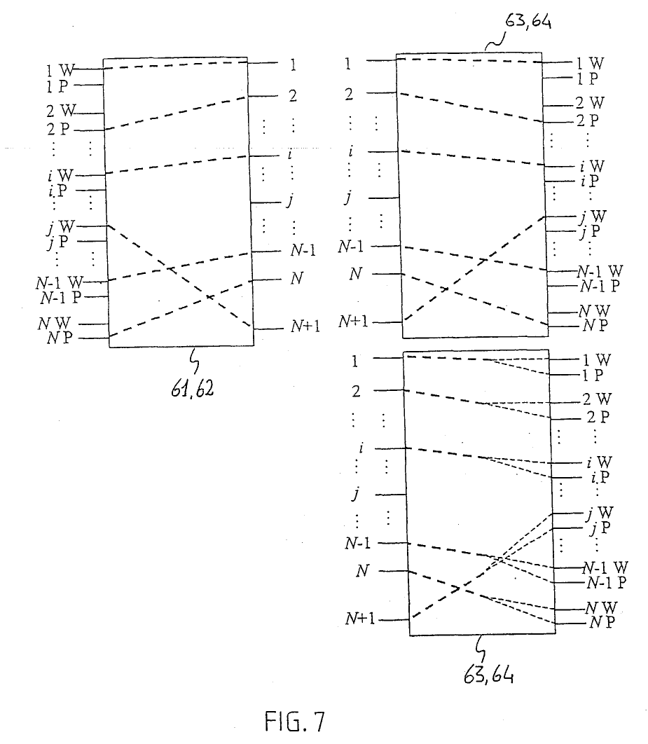

FIG. 7 illustrates the protection state of channel j: in the transmission unit 61, 62, one head (working head W or protection head P, carrying the effective signal of the respective transmitter TXn of the transmitting/receiving section 5) of each input i is connected to the corresponding output i, with the exception of input j, wherein a head (W in the case shown) thereof is connected to output N+1, while there is no effective signal at output j; in the receiving unit 63, 64, each input i is connected to the corresponding output i, with the exception of input j, which is connected to no output, while input N+1 is connected to output j. According to the strategy used, the signal can be sent to a single head (working W or protection P) of each output i, as exemplified in the top diagram, or to both heads W and P, as exemplified in the bottom diagram.

Various possible architectures for implementing the described functionality of the switching section 6 shall now be illustrated.

As shown in FIG. 8, in the case of single-head transmitting/receiving section 5, the transmitting switching units 61, 62 are provided with N working switches 611 of the 1×2 type, and a protection switch 612 of the N×1 type: each input i of the N inputs of unit 61, 62 is connected to the input of the respective working switch 611; one output of the N working switches 611 is respectively connected to one of the N working outputs of unit 61, 62; the second output of each working switch 611 is connected to a respective input of the protection switch 612, whose output, finally, is connected to the protection, or N+1, output of the transmitting switching unit 61, 62.

The connections between switches 611 and 612 are made by means of optical fibers.

In the working state, the working switches 611 are in such an operating condition as to connect the respective inputs, that is to say, inputs 1 to N of unit 61, 62, to the respective first outputs, that is, to the working outputs of the transmitting switching unit 61, 62. The state of the protection switch 612 is unimportant, since there is no optical signal at the input thereof.

In the state of protection of channel j, the jth working switch 611 is, after receiving a suitable command, preferably from the CPU associated to the switching unit mentioned before, in such an operating condition as to connect its input to its second output, that is, to the jth input of the protection switch 612, which finally connects its jth input to its output, that is, to the protection output N+1 of the transmitting switching unit 61, 62.

The implementation of the receiving switching unit 63, 64 is symmetrical with respect to that of unit 61, 62, that is, it has a protection switch of the 1×N type, and N working switches of the 2×1 type; thus, it shall not be described in detail.

The switches described before and hereafter can be discrete components in the different technologies illustrated in the introduction of the present disclosure, that is, opto-mechanical switches, MOEMS, thermo-optical switches, magneto-optical switches, solid-state switches. Preferably, however, the switching section 6 is manufactured in integrated optics; thus, it presents some advantages in terms of reduction of overall dimensions (more switches in a single package), reduction of costs, possibility of making some interconnections at chip level, thus reducing the external connections, and reduction of insertion losses.

In particular, electro-optical switches made on a lithium niobate substrate, for example, provide excellent performances in terms of switching time, which is lower than 1 ms, and of possibility of integrating several components.

In particular, the array 613 of the N working switches 611 is made on a single chip, thus obtaining a drastic reduction of the number of packages to be inserted into the unit, down to just two packages: one for array 613 of the working switches 611 and one for the protection switch 612. Array 613 and the protection switch 612 are optically connected in a known way through optical fibers.

On the contrary, when the transmitting/receiving sections 5 are of the double-head type, the transmitting switching unit 61, 62 is as shown in FIG. 9, and it is provided with N working switches 614 of the 2×2 type, and a protection switch 615 of the (N+1)×1 type: the two working W and protection P heads of each input of the transmitting switching unit 61, 62 are connected to the two inputs of the respective working switch 614; a first output of the working switches 614 is connected to a respective working output of the unit; the second outputs of the working switches 614 are connected to the protection switch 615, the output of which is connected to the protection output of unit 61, 62; input N+1 of the protection switch 615 has no connection, and thus, it does not present any traffic signal.

The connections between switches 614 and switch 615 are preferably made through optical fibers, and preferably, the array 616 of the working switches 614 is made in a single chip.

In the working state, the working switches 614 are in “bar” configuration if the working head W of the respective transmitter TXn has to be used, or, they are in “cross” configuration, if the protection head P of the transmitter TXn has to be used; in absence of failures, the protection switch 615 has its output connected to input N+1 so that there is no signal on the output.

In the protection state caused by a failure on channel j, the jth working switch 614 changes its status from “bar” to “cross” or vice versa, thus providing the jth signal to the input j of the protection switch 615; this protection switch 615 finally connects its output to the jth input, providing the jth signal to output N+1 or protection output of the transmitting switching unit 61, 62.

Nevertheless, it must be noted that, to maintain the transparency of the switching section 6, and thus, of the protected transmission system 1, at the input/output section or transmitting/receiving section 5, it cannot be assumed that the not operating head of transmitter TXn, P or W, does not provide any signal. This happens, for example, when a protection 1+1 is occurring at electric level upstream of the transmitters. Thus, the protection switch 615 can have, on each of its inputs connected to a working switch 614, a non-null signal, and thus it needs the input N+1 without connections so as to prevent that on the output there is signal also in absence of failures.

Alternatively, it is possible to provide for an N×1 switch the output of which is connected to an on/off switch or to a first input of a 2×1 switch.

The Applicant has noted that such an (N+1)×1 switch is difficult to be found on the market, since available switches usually have a number of inputs that is a power of 2. Moreover, such an (N+1)×1 component must ensure an extremely reduced cross talk. To solve this problem, it is possible to use special 2×2 arrangements for implementing the working switches 614, herein referred to as arrangements of the 2×2 “blocking” type, that is, such that one of their outputs is always without signal. These arrangements shall be described hereafter.

Finally, it is worth noting that the same transmitting switching unit 61, 62 with the working switches 614 of the 2×2 type is also suitable for transmitting/receiving sections 5 with single-head transmitters TXn, which shall be simply connected to a first input of the respective working switch 614, leaving the second input without connections. In this case, the protection switch 615 may also be of the N×1 type.

The receiving switching unit 63, 64 is symmetrical with respect to unit 61, 62, being provided with a protection switch of the 1×(N+1) type, and N working switches of the 2×2 type if there is no need of providing the output to both the two heads of receivers RXn of the transmitting/receiver section 5, but it is sufficient to send the signal to one of the two heads. Thus, said receiving switching unit 63, 64 is not described in detail. It must be noted that also in this case an additional port of the protection switch is needed so as not to send the signal that there may be on the protection channel to any head of receiver RXn. The 1×(N+1) switch has the same problems of availability and requirements of reduced cross talk already mentioned with reference to (N+1)×1 switch. In alternative, a protection switch of the 1×N type may be provided, having the input connected to an on/off switch or to a first output of an 1×2 switch.

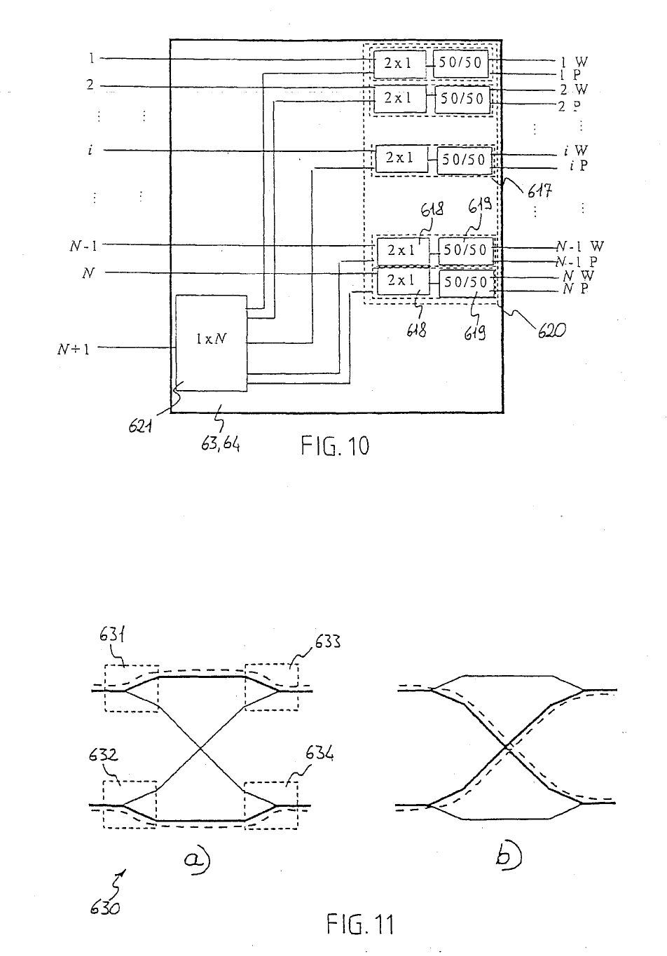

In case the signal is to be sent, at the reception, to both heads of each receiver RXn (broadcasting), and in any case, for preventing conflicts with possible 1+1 protections at an electric level of said elements, in the receiving switching unit 63, 64, illustrated in FIG. 10, each working switch 617 can advantageously comprise a 2×1 switch 618 followed by a 3-dB splitter 50/50 619. Moreover, numeral 620 refers to the array of said working switches 617, and numeral 621 refers to the protection switch, of the 1×N type. However, if 1×2 switches 618 do not have a high extinction ratio, the protection switch 621 preferably is of the 1×(N+1) type.

Preferably, also in this case electro-optical switches are used, made on a lithium niobate substrate, and it is possible to use optical fibers for connecting array 620 to the protection switch 621.

The Applicant has noted that 2×2 switches available on the market have an extinction ratio (defined in the introduction to this disclosure) generally lower than that required, although depending on the type of application. Thus, for the purpose of increasing the extinction ratio, the matrix of FIG. 11 is proposed, wherein a global 2×2 switch 630 has been obtained by using two 1×2 switches 631, 632, and two 2×1 switches 633, 634. More in particular, the inputs of the global switch 630 correspond to the inputs of the two 1×2 switches 631, 632; the first outputs of said switches 631, 632 are connected to respective inputs of the first 2×1 switch 633; and the second outputs of switches 631, 632 are connected to respective inputs of the second 2×1 switch 634. The outputs of 2×1 switches 633, 634 serve as outputs of the global 2×2 switch 630.

In this matrix, the four switches 631-634 are driven in parallel, and thus they switch at the same moment to pass from the “bar” configuration, shown in FIG. 11a, to the “cross” configuration of FIG. 11b, or vice versa (the dashed line indicates the signal path). Thus, it is a 2×2 switch 630 of the “non-blocking” type, that is to say, in which no connection among those possible is blocked, and in every configuration (cross or bar) there are always two active connections.

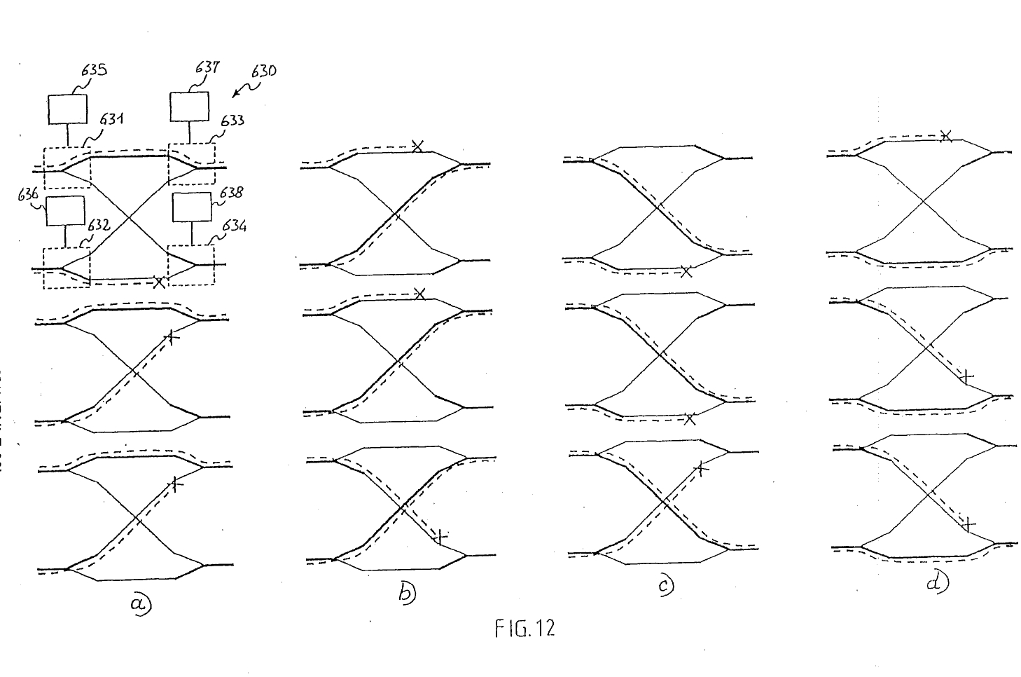

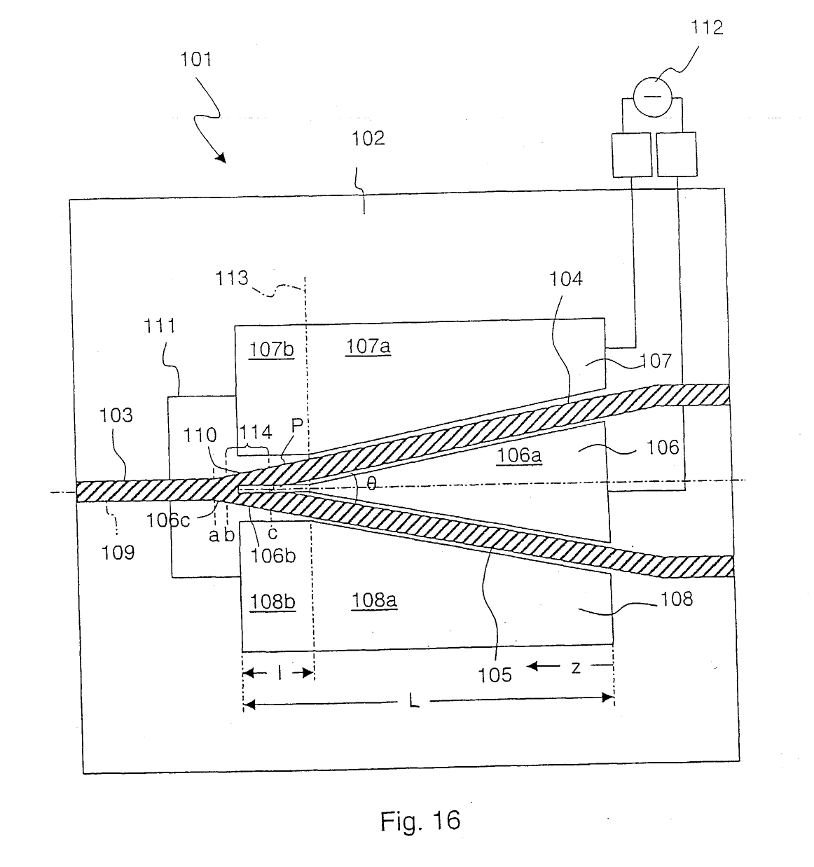

The Applicant has found that, by providing independently driven components 631-634 into such a 2×2 switch 630, it is possible to effect the desired connections, blocking the undesired ones. For this purpose, the CPU of the station is operatively connected to four driving circuits 635-638 (schematically shown in only one of the arrangements of FIG. 12, described hereafter) each of which is connected to a respective 1×2 or 2×1 switch so as to drive it independently of the others. The 1×2 and 2×1 switches can advantageously be digital optical switches (DOS) of the type that shall be described with reference to FIG. 16. The two waveguides that cross-connect 1×2 switches 631, 632 to 2×1 switches 633, 634, form, at the intersection, an angle sufficient to prevent crosstalk between signals. Preferably, said angle is greater than 6°, more preferably, greater than 10°. FIG. 12 illustrates the other twelve combinations of states of the component switches 631-634, which give four additional operating states obtainable by the global switch 630:

a) the first input is connected to the first output, the second input is blocked;

b) the second input is connected to the first output, the first input is blocked;

c) the first input is connected to the second output, the second input is blocked; and

d) the second input is connected to the second output, the first input is blocked.

In the use according to the present invention of said matrix 2×2 switch 630, in particular, it is possible to block the connections towards/from the protection switch in absence of failures, so that it does not need the auxiliary input and need only be a simple N×1 or 1×N switch, available on the market. In addition, it is possible to relax the specifications of said protection switch in terms of extinction ratio with respect to the case of (N+1)×1 switch wherein, in absence of failure, there are N input channels that must not reach the output.

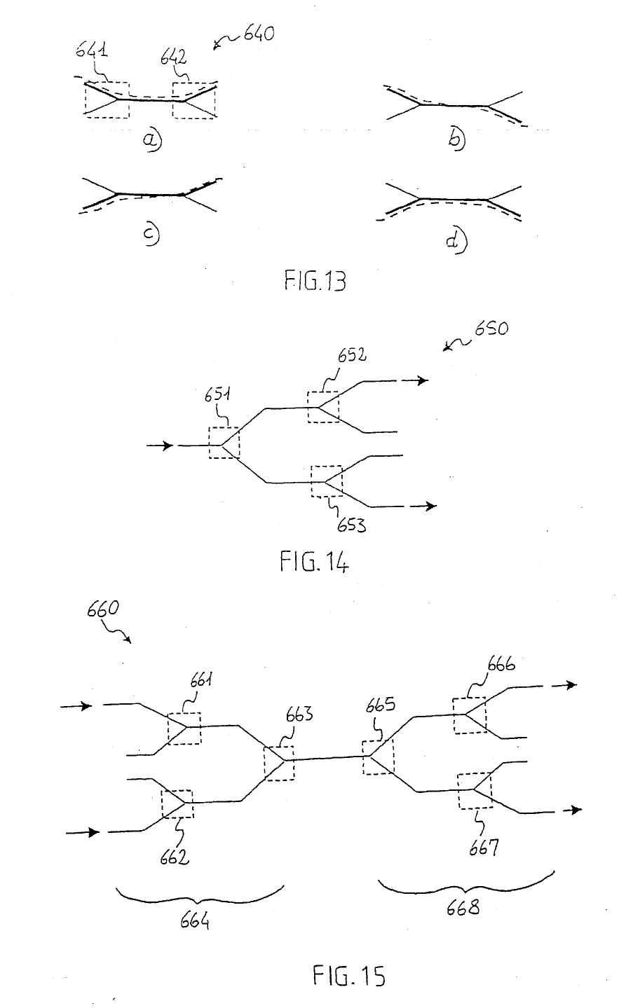

An alternative embodiment of a working 2×2 switch 640 of the blocking type is provided, as shown in FIG. 13, with a switch 641 of the 2×1 type, connected to a switch 642 of the 1×2 type. Switches 641 and 642 are commanded by respective driving circuits (not shown) independent from one another.

In the application in the transmitting switching unit 61, 62, in each channel, 2×1 switch 641 serves for selecting the working W or protection P head, while 1×2 switch 642 operates similarly to the working switch 611 of the case of single-head transmitting/receiving sections 5 illustrated in FIG. 8, thus it is clear that a protection switch of the N×1 type is sufficient.

To improve the value of the extinction ratio of Y-switches (refer, for example, to 1×2 switches 611 and 642, and 2×1 switches 618, 641), it is convenient to use a cascade arrangement as shown in FIG. 14 for an 1×2 switch 650. Said arrangement provides for a first switch 651 of the 1×2 type, the two outputs of which are respectively connected to a second switch 652 and to a third switch 653, also of the 1×2 type. The first output of the second switch 652 and the second output of the third switch 653 are used as outputs of the global 1×2 switch 650, whereas the second output of the second switch 652 and the first output of the third switch 653 are without connections.

This arrangement allows obtaining a higher value of the extinction ratio since the extinction ratios of the first and of the second switch 651, 652, or respectively, of the first and of the third switch 651, 653, expressed in dB, are added up. For example, arranging two switches in cascade with extinction ratio equal to 20 dB, the extinction ratio obtained is equal to 40 dB.

The configuration for a 2×1 switch is not shown as it is a mirror configuration, that is, it is comprised of three 2×1 switches.

FIG. 15 illustrates, for example, the arrangement of a blocking 2×2 switch 660 resulting from the application of the principle of FIG. 14 to the switch of FIG. 13. Said arrangement provides for three 2×1 switches 661-663 in the cascade configuration, forming a 2×1 switch 604, followed by three 1×2 switches 665-667, also in cascade configuration, forming an 1×2 switch 668.

FIG. 16 shows an optical-signal digital switching/modulating device 101 suitable to be used as 1×2 or 2×1 switch in the switching section 6.

Device 101 comprises, on a substrate 102, preferably of an electro-optical material, a first, a second and a third waveguides 103-105, for conveying the light, and electrodes 106, 107 and 108 for the electrical control of the same device 101. Device 101 has a plane of substantial symmetry normal to the plane of the figure, and defining an axis 109 in the plane of the figure.

Substrate 102 can be made of materials with different optical properties. Preferably, substrate 102 is made of lithium niobate (LiNbO₃) or of another material having, as lithium niobate, an electro-optical effect, such as for example lithium tantalate (LiTaO₃). Alternatively, substrate 102 can be made of a polymeric material.

When a lithium niobate substrate 102 is used, said structure is advantageously oriented with cut perpendicular to x axis (x-cut), and the direction of propagation of the light is preferably selected as coinciding with y axis (y-propagation). Alternatively, the structure can comprise a substrate with cut perpendicular to y axis (y-cut) and with propagation of the light substantially along axis x (x-propagation). Such a structure presents reduced phenomena of thermal drift (that is, reduced variations of the working point due to temperature variations) and it requires relatively reduced values of the difference of potential needed for switching or attenuating the light. As further alternative, the substrate can be of the type with cut along z axis (z-cut) and with direction of propagation along x axis (x-propagation) or along y axis (y-propagation).

In all the above cases, the structure of the device is such that the optical signals have effective directions of propagation, substantially defined by the directions of extension of the waveguides in which the signals themselves propagate, forming angles that are preferably smaller than 2° with the main axis of the crystal that defines, as described above, the direction of propagation.

Waveguides 103-105 are made by laying, on substrate 102, a layer of titanium having a smaller thickness than 500 nm, more preferably comprised between 50 nm and 150 nm, and successively defining its contours through photolithographic methods, and finally, by thermally diffusing the residual titanium inside the underlying substrate 102. Preferably, waveguides 103-105 are substantially straight, and they have a substantially constant width, so as to allow the propagation of a single mode.

The device of FIG. 16 is an Y-switch that can function both as 1×2 switch (when the light enters from the first waveguide 103 and exits alternatively from the second waveguide 104 or from the third-waveguide 105), and as 2×1 switch (when from the first waveguide 103 alternatively exits the light entering from the second or from the third waveguide 104, 105).

The first waveguide 103 substantially extends along axis 109, whereas the second and the third waveguide 104, 105, which define the two arms of the Y, are symmetric with one another with respect to axis 109, and they are separated by a preselected angle θ starting from a bifurcation point P (located along axis 109). Angle θ, preferably smaller than 2°, must be as small as possible compatibly with the dimensions of device 101.

Alternatively, the second and the third waveguide 104, 105 can be asymmetrically arranged with respect to axis 109, they can have different widths, or have a non-rectilinear extension (for example, with curvature towards axis 109, as described in patent U.S. Pat. No. 5,123,069).

Waveguides 103-105 are connected through a connection waveguide 110, approximately delimited in the Figure by the dashed segments a and c normal to axis 109. The connection waveguide 110 progressively widens passing from the area communicating with the first waveguide 103 to the area communicating with the second and the third waveguide 104, 105. The connection waveguide 110 comprises a multi-mode (for example, dual-mode) waveguide region 114, substantially confined between two longitudinal positions indicated (in an approximate way) through dashed segments b and c (normal to axis 109). In the multi-mode region 114, the width of the connection waveguide is such as to allow the transmission of at least one higher order mode besides the fundamental mode.

Electrodes 106-108 include a central electrode 106 arranged between the second and the third waveguide 104, 105 and a first and a second external electrode 107, 108, arranged at opposed sides of the second waveguide 104 and of the third waveguide 105, respectively, with respect to the central electrode 106. Electrodes 106-108 are suitable to generate an electric field region so as to vary, as described hereafter, the refractive index of at least one of waveguides 104 and 105.

Preferably, electrodes 106-108 have a same length L (measured along a direction parallel to axis 109) and they form, as a whole, a substantially rectangular structure. Electrodes 106-108 can be made by laying a layer of conductor material, for example titanium, on the surface of substrate 102 previously covered with a layer of insulating material, for example silicon dioxide SiO2, and then applying a photolithography technique of the known type to provide the electrodes with the desired shape. When electrodes 106-108 are made of titanium, their thickness is preferably smaller than about 500 nm, more preferably it is comprised between about 50 nm and about 150 nm.

The central electrode 106 comprises a main portion 106a preferably having a substantially triangular shape, with two symmetrical sides with respect to axis 109, respectively adjacent the second and the third waveguide 104, 105, and with the vertex between said sides arranged in proximity of the bifurcation point P of the second and third waveguides 104, 105. Advantageously, the central electrode 106 is provided with an appendix 106b, substantially straight, with a preselected length l, which extends along axis 109 and inside the multi-mode region, starting from the vertex of the main portion 106a. The figure shows, for convenience of description, a dashed line 113 normal to axis 109, which defines the point from which appendix 106b extends. The length of appendix 106b is such that one first end 106c thereof is arranged inside the multi-mode region.

The extinction ratio of device 101, defined by the relation E.R.=10 log P_{H}/P_{L}, already described before, is a function of the length of appendix 106b, in particular of the position inside the multi-mode region of end 106c of appendix 106b.

In particular, the Applicant has found that, for some values of the length of appendix 106b, the extinction ratio is particularly high. Said behaviour can be observed for both polarizations of light TE, TM. Advantageously, the length of appendix 106b (and thus, the position of end 106c) is selected so as to have the highest values of extinction ratio.

Preferably, the outer electrodes 107 and 108 are symmetrical with one another with respect to axis 109, and they have a substantially trapezoidal shape. Each of the outer electrodes 107, 108 has an oblique side adjacent a respective waveguide 104 or 105 on opposite sides with respect to the central electrode 106.

Preferably, at the multi-mode region, the distance between the outer electrodes 107 and 108 is substantially constant. Moreover, the distance of the outer electrodes 107 and 108 from appendix 106b is, at least at the multi-mode region, preferably the same. In this way, in the multi-mode region 114 it is possible to have, in the area taken by the electrodes, a substantially constant electric field with a relatively high value. The portions of the outer electrodes 107 and 108 having substantially constant mutual distance preferably extend outside the multi-mode region 114, more preferably up to the initial portion of appendix 106b (that is, up to the dashed line 113).

The portions of the electrodes 106-108 adjacent the second and the third waveguide 104 and 105 extend up to a longitudinal position whereat the coupling of modes between the second and the third waveguide 104, 105 is substantially null. Said end of electrodes 106-108 defines a second longitudinal end opposed to the first one. The second and the third waveguide 104, 105 preferably terminate at an end of substrate 102, and they can be coupled to planar structures in optical waveguide or optical fibers (not shown in FIG. 16)

The outer electrodes 107 and 108 are preferably electrically connected to one another through a conductor bridge 111, made on substrate 102 above the first waveguide 103, which maintains them at the same potential. Moreover, one of the two outer electrodes 107, 108 (in the specific case, the one referred to with 107) and the central electrode 106 are electrically connected to the poles of a voltage generator 112. In this way, between the central electrode 106 and the two outer electrodes 107, 108, it is possible to establish a difference of electric potential ΔV, which induces a controllable electric field in the region taken by waveguides 104 and 105 and in the connection region 110.

Device 101 operates as follows.

Consider the operation as an 1×2 switch. If the potential difference ΔV applied to electrodes 106-108 is null, the light entering into device 101 through the first waveguide 103 comes out from device 101 equally split between the second and the third waveguide 104, 105. On the contrary, if a non-null potential difference ΔV is applied between electrodes 106 and 107, the electric field thus generated induces, by electro-optical effect, an increase +Δn of the refractive index in one of the waveguides 104, 105, and an equivalent decrease −Δn of the refractive index in the other waveguide 105, 104. As a consequence, there is an increase in the optical power guided by the waveguide with greater refractive index and, at the same time, a reduction in the optical power guided by the other waveguide. In practice, the power of the single-mode signal supplied to the connection region 110 by the first waveguide 103 shall distribute between waveguides 104, 105 according to the above potential difference. In particular, if the applied potential difference ΔV is sufficient to have the complete switching, the single-modal signal exiting from the waveguide with higher refractive index shall have an optical power substantially equal to that of the signal entering into device 101, while the optical power exiting the waveguide with lower refractive index shall be substantially null.

Similarly, when used as 2×1 switch, device 101 is capable of selecting, among the single-mode signals entering through waveguides 104, 105, the one to be sent in output through the first waveguide 103. In practice, applying a potential difference ΔV sufficient to have the complete switching, the single-mode signal entering through the waveguide with lower refractive index shall be irradiated into substrate 102, and the first waveguide 103 shall receive only the single-mode signal coming from the waveguide with higher refractive index.

A switching device of the 2×2 type, also usable in the switching section 6, can substantially be implemented as the device just described, inserting in place of the first waveguide 103, two waveguides defining with one another substantially the same angle as that formed by waveguides 104, 105. Also these waveguides are preferably symmetrical with respect to the axis, and they are preferably straight. However, unlike the third and the fourth waveguide 104, 105, which preferably have the same width, said waveguides preferably have different width. For example, one of said waveguides can have a width equal to that of the third and fourth waveguide 104, 105, whereas the other can have a smaller width. Such a difference of width reduces the optical coupling between said waveguides, since it implies a difference of refractive index; thus, the fundamental propagation modes have different propagation constants, and they are thus “asynchronous”. Said asynchrony condition can alternatively be obtained by making one of said waveguides curved.

The 1×N (N×1) switches of the switching section 6, when implemented in integrated optics, can comprise a plurality of 1×2 (2×1) switches of the type described above, in a tree configuration, made on a same substrate. 1×N switches in integrated optics are, for example, described in A. C. O'Donnell, “Polarization independent 1×16 and 1×32 lithium niobate optical switch matrices”, ELECTRONICS LETTERS, Dec. 5, 1991, Vol. 27, No. 25.

The (N×1)×1 switch can be implemented in integrated optics starting from an N×1 tree structure, inserting a further 2×1 switch downstream of the branching. The disadvantage of said component is that it implies a waste of space on the chip, since the addition of a further 2×1 switch requires an increase in the length of the chip itself similarly to what is required for the addition of an entire branching stage.

Also for summary purposes, it is hereafter described, with reference to FIGS. 17 and 18, the operation of the shared protection provided according to the present invention. However, since—as pointed out—it is an 1:16 protection, meaning that the 32 traffic signals λ′₂, λ′₃₃ are divided into two groups of sixteen channels each, each protected independently of the other through a respective protection channel λ₁ and λ₃₄, reference shall be made, in the following description, to a subsystem comprised of only sixteen working channels 1 to N, and a protection or N+1 channel. In addition, the case of bidirectional transmission and where the input/output sections are double-head transmitting/receiving sections 5 is depicted, since it poses more difficulties than the single head case, the simplifications needed for this case thus being within the abilities of one skilled in the art.

FIG. 17 shows the “working” operating condition of the system, that is to say, in which all signals are transmitted from station 2 to station 3 through the working paths S1, S2, . . . , SN (schematically shown) and vice versa, from station 3 to station 2 through the return working paths S1′, S2′, . . . , SN′ (schematically shown).

More in particular, from one head of the respective transmitter TXn 51 of the input/output section 5, the signal Sn at wavelength λ′n passes through the respective working switch 614 of the transmitting switching unit 61 and the respective transmitting transponder TXTn 71 of the wavelength converter section 7, where it is converted to wavelength λn, and the overhead is juxtaposed to it. The N traffic signals are multiplexed in the multiplexing subsection 81 (herein schematically indicated), amplified as a whole in preamplifier 91 of the amplification section 9 and transmitted along the communication line 4 to the subsequent station 3, where they are amplified by preamplifier 92 of the amplification section 9 and demultiplexed in the demultiplexing subsection 82 (herein schematically indicated). Then, each signal Sn passes through the respective receiving transponder RXTn 73, where the overhead is dropped, and it is converted to wavelength λn, then, it goes through the respective working switch of the receiving switching unit 63 and reaches the respective receiver RXn 53 of the transmitting/receiving section 5, on one—or, as shown—on both heads W and P.

The dashed lines SP, SP′ indicate the “protection paths” that, preferably, in the working state of system 1 shown in FIG. 16, do not carry effective signal, or they carry a monitoring signal, at the protection wavelength λₙ₊₁, generated in each direction by the shared transmitting transponder TXT-N+1 and received by the shared receiving transponder RXT-N+1, also through the multiplexing/demultiplexing sections 8, the amplification sections 9 and the communication line 4. The use of the monitoring signal, in particular, of an AMS (Alarm Maintenance Signal), coded in a FEC (Forward Error Correction) frame, serves for monitoring the protection line, equalizing the total power in the communication line 4, and so on. Said signal comprises a preset sequence of 1 and 0 organised with a scrambling method to have a mean power similar to that of the other signals, thus preventing crosstalk problems between adjacent channels; it is added to the frame portion intended for transporting the effective signal (payload), and it advantageously allows checking the status of the protection path measuring the BER (bit error rate).

It is worth noting that the working paths Sn, Sn′, and the protection paths SP, SP′ of stations 2, 3, can be comprised of elements other than the transponders, multiplexers/demultiplexers and amplifiers shown, since the principle at the basis of the invention can also be applied to different transmission systems, not in wavelength multiplexing.

Moreover, FIG. 17 shows some optical failure detectors, labelled as PD and DECT, communicating with the CPU processor of the switching section 6 of the respective station, as schematically shown by the thick arrows. Although the optical failure detectors have been shown (for clarity) only in the path of channel λ1, it is intended that analogous detectors are provided in the path of every other channel, in both transmission directions.

More in particular, the optical failure detectors labelled as PD are essentially comprised of a photodiode, which receives a small signal percentage, through a power splitter labelled as 1/99 (of course, it shall be understood that said label is purely illustrative, as power splitters with a different ratio, for example 5/95, can be used). If the photodiode of the optical failure detector PD does not receive power, said condition indicates absence of signal in the point concerned, that is, it indicates a failure at or upstream of, said point.

The optical failure detectors labelled as DECT essentially comprise, besides a photodiode as in the case of the above-described detectors PD, a bit frequency measurement device and/or a bit error rate (BER) measurement device, both of the known type.

Said optical failure detectors PD, DECT are preferably positioned at all inputs and outputs of the switching sections 6 and at all transponders TXTn and RXTn. Such an arrangement, as it shall be evident to a man skilled in the art, is exemplificative of the points in the system to be monitored. In fact, the critical points of a system such as that shown are recognisable in the connections between the various sections and in the transponders themselves. However, it shall likewise be evident that, for the purposes of the mere detection of a failure without identifying the component or the connection causing the failure, a failure detector downstream of all connections and components of the working and protection paths would be sufficient. Finally, it is worth noting that also the indication of detector as of the PD or DECT type in each point is exemplificative, the effective choice of the type of detector in each point being dictated by considerations of cost, overall dimensions and specificity of the desired detection.

FIG. 18—wherein the references have partly been omitted—illustrates the protection state in the hypothesis of failure on channel 1 in the direction from station 2 to station 3. Moreover, for sake of simplicity, paths S2, S3, . . . , SN, S2′, S3′, . . . , SN′, of the other traffic signals have been omitted, since they are equal to those in the working state of FIG. 17.

Upon a failure on the working path S1, as detected by an optical failure detector PD, DECT, if the protection path is valid, as it shall be better explained hereafter, in station 2 the traffic from transmitter TX1 is readdressed by the working switch 614 associated to channel 1 onto the corresponding input of the protection switch 615. Said protection switch 615 functions as a selector, addressing the incoming signal towards the shared transmitting transponder TXT-N+1, which converts it to the protection wavelength λₙ₊₁. During reception in station 3, the traffic relating to the protected channel 1 is received on the corresponding shared receiving transponder RXT-N+1 and readdressed through the protection switch 615 towards the respective working switch 614, from which it reaches the respective receiver RX1.

The management of the traffic of signals in the opposed direction, that is, from station 3 to station 2, depends on the particular type of 1:N protection strategy used. In particular, in a bidirectional transmission system, the 1:N protection can be a single-ended protection or a dual-ended protection. In the first case, when a failure occurs on one working path j in one direction, for example east-west, only the communication in said direction is switched onto the protection path, while in the second case, also the communication along the working path j in the opposed direction, west-east in this example, is switched onto the respective protection path.

Single-ended protection presents the advantages of being easy to implement, faster, and of allowing the restoration of the traffic in case of double failure, with suitable expedients, on condition that the failures are not in the same direction. On the other hand, dual-ended protection is more symmetrical; it allows an easier repairing of the failures since the span interested by the failure does not carry traffic in any direction; and it maintains the delays equal for both directions.

Thus, in the direction of transmission from station 3 to station 2, in compliance with the single-ended protection strategy, the signal remains on the return working path S1′, leaving the return protection path SP′ available for other possible channel failures concerning the propagation from station 3 to station 2.

On the contrary, in compliance with the dual-ended protection strategy, also in the direction of transmission from station 3 to station 2, the signal is switched onto the return protection path SP′ indicated by the dashed lines.

As exemplification, the operation of the system in the hypothesis of centralised control shall now be illustrated, that is, wherein the communication of the protection protocol and the switching control are based on a central processing unit (CPU) provided inside the switching section 6, which is connected, for a bidirectional communication, to all components interested by the protection procedures. Of course, a localised control is also possible, that is, based on a direct exchange of information between the components interested by the protection procedure, that is, between the failure detectors, the switches of the switching section 6 and the components of the communication paths, in particular, transponders TXTn and RXTn.

As regards the protection protocol, a protocol similar to that provided for by the ITU-T Recommendation G.841 (October 1998), described in the introduction to the present description, can be used. Moreover, hereinafter reference shall be made to a confirmed protocol, that is, in which the failure warning returns to the point of failure detection before carrying out the complete switching of the switching section 6. A less preferred solution, since it is less reliable, consists in using a non-confirmed protocol.

In any case, as said before, the protection protocol is of the software type, wherein the relating bit sequence is written on some Bytes of the overhead (optical channel header or Och-H) added by the transmitting transponder TXTn with FEC (Forward Error Correction) to the frame (usually, SDH/SONET) of the incoming optical signal and terminated/dropped by the receiving transponder RXT with FEC.

The various steps in case of single-ended protection shall now be illustrated.

As indicated by step (a) of FIG. 18, in case of failure on channel 1, detector DECT at the receiving transponder RXT1 of station 3 sends a warning of this to the CPU of station 3. Of course, said failure warning can also come from one of the other detectors associated to channel 1 inside station 3.

Then, the CPU processor of station 3, carries out the following steps:

(b) queries the optical failure detector DECT associated to the protection transponder RXT-N+1 of station 3 to check that the protection line is operating (said check can occur through another one of the detectors associated to the protection path, and it requires that a monitoring signal always propagates on the protection path, as specified above);

(c) signals the failure information to the transmitting protection transponder TXT-N+1 of station 3 so as to retransmit it towards section 2 (that is, so as to code, into the overhead bytes, the protection request and the indication of the failed channel);

(d) switches the protection switch 615 of the receiving switching unit 63 of station 3 so as to connect the protection channel to the proper working switch 614 of the same unit to prepare the protection path SP.

When the receiving transponder RXT1 of station 2 decodes the information relating to the occurrence of the failure on channel 1 in the direction from station 2 to station 3, it communicates the failure information to the CPU processor 60 of the same section 2 (step (e) of FIG. 17), which then carries out the following steps:

(f) queries the input optical failure detector PD associated to channel 1 to check whether the problem is at level of the input/output section 5 or at level of the working path; in the first case, if there is an alternative head, the working switch associated to channel 1 is switched onto said head, the protection request is aborted and the initial working condition is restored;

(g) activates the transmitting protection transponder 71 of station 2 so that it sends the reply to the protection request, that is, the confirmation of the occurred switching on the protection path into station 2 or the signal to abort the protection request;

(h) activates the protection switch 615 of the transmitting switching unit 61 of station 2 so as to connect the protection channel to the working switch 614 associated to channel 1;

(i) activates the switching of the corresponding working switch 614 of the transmitting switching unit 61 of station 2 so that, at the output, it addresses signal 1 towards the protection switch 615, that is, towards the protection path prepared in step (h).

In step (j), the protection receiving transponder RXT-N+1 of station 3 decodes the information relating to the occurred switching onto the protection path in station 2 and communicates it to the CPU processor 60 of the same station 3;

finally, in step (k), the CPU processor 60 of station 3 activates (after having ensured that the effective correspondence between the switched channel and that for which the protection request had been sent) the switching of the working switch 614 associated to channel 1 of the receiving switching unit 63 of station 3 so that, at the input, it gets the signal coming from the protection switch 615, that is, the signal coming from the protection path, thus effectively completing the switching.

The sequence of steps outlined above must be regarded as exemplificative. If, for example, the failure occurs upstream of the transmitting transponder TXT-1, the corresponding failure detector DECT immediately sends the warning to the CPU processor of station 2, which can thus carry out in advance steps (f, h).

The switchings of the steps referred to with (h) and (i) can advantageously occur at the same time and, preferably, they can be implemented in wired logics, so as to achieve a faster and safer switching.

A man skilled in the art shall easily understand how the above method should be modified to obtain a dual-ended protection, as well as how it should be simplified in the case of non-confirmed protocol, that is, in the case in which the switching onto the protection path in the station wherein the failure is detected occurs at the same time as the warning to the other station, without waiting for the acknowledgement signal of the protection request.

Finally, it must be noted that, in case of a unidirectional transmission system, it shall be sufficient to provide for a “protocol path” between station 2 and station 3 for the communication of the protection protocol.

As described in step (f), the protection procedure is interrupted if the failure is located at the level of the input/output section 5 and the signal is correctly received by an alternative head.

Moreover, the procedure is interrupted if the failure is located at the level of the input/output section 5 but the signal cannot be received correctly, for example because there is no alternative head (single-head) or because also on the alternative head the signal cannot be received correctly; in this case, in fact, the signal cannot be correctly transmitted in the system, and it is necessary to identify and correct the failure at the level of the input/output section 5.

Thus, in general, the protection procedure consequent to a failure detection on a working path, comprising the step of optically deviating, both in the first station 2 and in the second station 3, the corresponding signal on a shared protection path, is completed if it is checked that the signal arrives correctly from the relating transmitter 51 through a corresponding optical connection.

In order to detect the presence of a failure on a working path and to check the correct reception of the relating transmitter 51, along the working paths and, respectively, along the optical connections to transmitters 51, the conformance of the signals with preset requirements is checked, thanks to the failure detectors PD and DECT. Said conformance check comprises at least one of the following checks:

that the optical power is at least equal to a preselected power;

that the bit frequency is equal to a preselected bit frequency;

that the error rate is lower than a preselected error rate.

1. Linear optical transmission system (1) comprising:
a first (2) station for transmitting a plurality of optical signals,
a second (3) station for receiving said plurality of optical signals,
at least one optical communication line (4) between the first and the second station (2, 3)
both said first station (2) and said second station (3) defining, for each signal of said plurality of optical signals, a respective optical communication working path,
characterised in that:
at least in said second station (3), each working path is associated to at least one respective optical failure detector (PD, DECT),
both said first station (2) and said second station (3) further define a optical communication shared protection path,
it comprises a protocol path for the communication between the first (2) and the second (3) station of a protection protocol at least upon the failure detections by said optical failure detectors (PD, DECT),
and in that each of said stations (2, 3) comprises an optical switching section (6) interposed along said working paths for optically switching, in response to the detection of a failure by one of said optical failure detectors (PD, DECT), the corresponding optical signal from the corresponding working path to the protection path.

2. System according to claim 1, characterised in that each of said stations (2, 3) comprises optical failure detectors (PD, DECT) at the input of said switching section (6) and/or at the output of said switching section (6).

3. System according to one of the preceding claims, characterised in that each of said stations (2, 3) further comprises at least one optical failure detector (PD, DECT) associated to the protection path, and in that said switching section (6) carries out the switching only in absence of a failure detection by said optical failure detector (PD, DECT) associated to the protection path.

4. System according to one of the preceding claims, characterised in that each of said optical failure detectors (PD, DECT) comprises a photodetector for detecting the optical power.

5. System according to claim 4, characterised in that a group of said optical failure detectors (PD, DECT) comprises a bit frequency measurement device and/or a bit error rate measurement device.

6. System according to one of the preceding claims, characterised in that each of said stations (2, 3) comprises a wavelength converter section (7) for converting said optical signals of each of said working paths and/or of said protection path from first wavelengths (λ′₂-λ′₁₇; λ′₁₈-λ′₃₃) into second wavelengths (λ₁-λ₁₇; λ₁₈-λ₃₄) or vice versa.

7. System according to one of the preceding claims, characterised in that said first station (2) comprises a multiplexing section (81) for multiplexing said optical signals of said working paths and/or of said protection path into a multiplexed signal, and said second station (3) comprises a demultiplexing section (82) for demultiplexing said multiplexed signal into said optical signals on said working paths and/or on said protection path.

8. System according to any one of the preceding claims, for bidirectional transmissions, wherein both said first station (2) and said second station (3) further define as many return working paths as said working paths, and a return protection path, wherein each of said return working paths is associated to at least one respective return failure detector and wherein said switching sections (6) are further configured so as to further optically switch, in response to the detection of a failure by one of said return failure detectors (PD, DECT), the corresponding optical signal between the corresponding return working path and the return protection path.

9. System according to claim 8, characterised in that in each of said stations (2, 3), each of said working paths corresponds to a return working path, and in that said switching sections (6) are further configured so as to further optically switch, in response to the detection of a failure on one of the working paths by a corresponding failure detector (PD, DECT), the optical signal carried on the corresponding return working path onto the return protection path.

10. System according to claim 8 or 9, characterised in that said protocol path comprises said protection path and said return protection path of each of said stations (2, 3), the signal coding the protection protocol being juxtaposed to the respective optical signal.

11. System according to any one of the preceding claims, characterised in that each of said stations (2, 3) comprises a processor (CPU) connected to said optical failure detectors (PD, DECT) of the respective station (2, 3) for receiving said failure detections, suitable to communicate with the processor (CPU) of the other station (3, 2) through said protocol path and suitable to control the switching section (6) of the respective station (2, 3) according to said failure detections by said optical failure detectors (PD, DECT) and to said protection protocol.

12. System according to any one of the preceding claims, characterised in that at least the switching section (6) of said first station (2) is provided with at least one transmitting switching unit (61, 62) having:
associated to each of said working paths, a working input, a working switch (611; 614) and a working output,
associated to said protection path, a protection switch (612; 615) and a protection output,
wherein each of said working switches has a first state in which the respective working input is coupled to the respective working output, and a second state, in response to a failure detection by one of said optical failure detectors (PD, DECT) associated to the respective working path, wherein the respective working input is coupled to said protection switch, and
wherein said protection switch has as many states as said working paths, in each of which states, in response to the detection of a failure by one of said optical failure detectors (PD, DECT), the respective working switch is coupled to said protection output.

13. System according to claim 12, characterised in that said working switches of said at least one transmitting switching unit (61, 62) are 1×2 switches (611).

14. System according to any one of the preceding claims, characterised in that at least the switching section (6) of said second station (3) is provided with at least one receiving switching unit (63, 64) having:
associated to each of said working paths, a working input, a working switch (618) and a working output,
associated to said protection path, a protection input and a protection switch (621),
wherein each of said working switches has a first state in which the respective working input is coupled to the respective working output, and a second state, in response to a failure detection by one of said optical failure detectors (PD, DECT) associated to the respective working path, wherein said protection switch is coupled to the respective working output, and
wherein said protection switch has as many states as said working paths, in each of which states, in response to the detection of a failure by one of said optical failure detectors (PD, DECT), said protection input is coupled to the respective working switch.

15. System according to claim 14, characterised in that said working switches of said at least one receiving switching unit (63, 64) are 2×1 switches.

16. System according to claim 14, characterised in that said working switches (617) of said at least one receiving switching unit (63, 64) are each comprised of a 2×1 switch (618) followed by a beam splitter 50/50 (620).

17. System according to claims 12 and 14, characterised in that said working switches of said at least one transmitting switching unit (61, 62) and/or said working switches of said at least one receiving switching unit (63, 64) are 2×2 switches (614).

18. System according to claim 17, characterised in that said working 2×2 switches (614) are each comprised of two 1×2 switches (631, 632) and two 2×1 switches (633, 634), wherein the inputs of the working 2×2 switch (630) correspond to the inputs of the two 1×2 switches (631, 632), the first outputs of said two 1×2 switches (631, 632) are connected to respective inputs of the first 2×1 switch (633), the second outputs of 1×2 switches (631, 632) are connected to respective inputs of the second 2×1 switch (634) and the outputs of 2×1 switches (633, 634) correspond to the outputs of said working 2×2 switch (630).

19. System according to claim 18, characterised in that each of said two 1×2 switches (631, 632) and said two 2×1 switches (633, 634) is provided with a respective driving circuit (635-638), said driving circuits (635-638) driving the respective 1×2 or 2×1 switches (631-634) in an independent way from one another.

20. System according to claim 17, characterised in that said working 2×2 switches (614) are each comprised of a switch (641) of the 2×1 type connected to a switch (642) of the 1×2 type.

21. System according to one of claims 13 and 20, characterised in that said 1×2 switches (650) are each comprised of a first (651), a second (652) and a third (653) 1×2 switch, wherein the input of the first switch (651) serves as input of said 1×2 switch (650); a first output of the first switch (651) is connected to the input of the second switch (652), the first output of which serves as first output of said 1×2 switch (650) and the second output of which is without connections, and a second output of the first switch (651) is connected to the input of the third switch (653), the first output of which is without connections and the second output of which serves as second output of said 1×2 switch (650).

22. System according to one of claims 15, 16 or 20, characterised in that said 2×1 switches are each comprised of a first, a second and a third 2×1 switch, wherein a first input of the first switch serves as first input of said 2×1 switch, the second input of the first switch is without connections, and the output of the first switch is connected to a first input of the third switch, a first input of the second switch serves as second input of said 2×1 switch, the second input of the second switch is without connections and the output of the second switch is connected to a second input of the third switch, the output of the third switch serves as output of said 2×1 switch.

23. System according to any one of claims 12 to 22, characterised in that said working switches of said at least one transmitting switching unit (61, 62) and/or said working switches of said at least one receiving switching unit (63, 64) are made on a single chip.

24. System according to any one of claims 12 to 22, characterised in that said working switches and/or said protection switch of said at least one transmitting switching unit (61, 62) and/or said working switches and/or said protection switch of said at least one receiving switching unit (63, 64) are selected from the group consisting of opto-mechanical switches, MOEMS switches, thermo-optical switches, magneto-optical switches, solid-state switches and digital optical switches.

25. Method for linear optical transmission with failure protection between a first and a second station connected through at least one optical communication line, comprising the steps of:
receiving, in said first station, a preselected number of optical signals through respective input optical connections;
optically conveying said signals along respective working paths in said first station, along said at least one communication line and along respective working paths in said second station;
characterised in that it comprises the steps of:
carrying out a first check of the conformance with preset requirements of each of said signals along the respective input optical connection;
carrying out a second check of the conformance with preset requirements of each of said signals along the respective working path of said first station and/or along the respective optical working path of said second station;
optically deviating, both in said first station and in said second station, any one of said signals onto a shared protection path optically coupled to said at least one communication line, in case said first check on said signal gives a positive result but said second check on said signal gives a negative result.

26. Method according to claim 25, characterised in that it comprises the additional steps, executed should said first check on one of said signals give a negative result, of carrying out a third check on said signal through a respective additional input optical connection and, should said third check give a positive result, receiving said signal through said additional input optical connection.

27. Method according to claim 25 or 26, characterised in that it comprises the steps of:
receiving, in said second station, as many additional optical signals as said preselected number;
optically conveying said additional signals along respective additional working paths in said second station, along said at least one communication line and along respective additional working paths in said first station; each of said additional working paths corresponding to one of said working paths;
optically deviating, both in said first station and in said second station, any one of said additional signals on an additional shared protection path, in case for the corresponding signal, said first step of checking gives a positive result, but said second step of checking gives a negative result.

28. Method according to any one of claims 25 to 27, characterised in that each of said first and second checking steps comprises at least one of the following steps:
checking that the optical power is at least equal to a preselected optical power;
checking that the bit frequency is equal to a preselected bit frequency;
checking that the error rate is lower than a preselected error rate.

29. Optical switching device suitable to be used in the transmission system of claim 1, comprising two 1×2 switches (631, 632) and two 2×1 switches (633, 634), wherein the inputs of said switching device (630) are the inputs of the two 1×2 switches (631, 632), the first outputs of said two 1×2 switches (631, 632) are connected to respective inputs of the first 2×1 switch (633), the second outputs of 1×2 switches (631, 632) are connected to respective inputs of the second 2×1 switch (634), and the outputs of 2×1 switches (633, 634) are the outputs of said switching device (630), characterised in that it comprises, for each of said 1×2 and 2×1 switches, a respective driving circuit (635) suitable to drive each of said 1×2 and 2×1 switches (631-634) independently of the others.

30. Device according to claim 29, characterised in that said 1×2 and 2×1 switches are digital optical switches made on a same semiconductor substrate.
